(19) United States
(12) Patent Application Publication
(10) Pub. No.: US 2026/0028726 A1
(43) Pub. Date: Jan. 29, 2026

(54) METHODS, CATALYSTS AND SYSTEMS FOR PERFORMING ELECTROCHEMICAL CARBON DIOXIDE REDUCTION REACTIONS IN STRONG ACIDIC MEDIUM

(71) Applicant: City University of Hong Kong, Hong Kong (HK)

(72) Inventors: Ruquan YE, Hong Kong (HK); Yun SONG, Hong Kong (HK)

(21) Appl. No.: 19/283,277

(22) Filed: Jul. 29, 2025

Related U.S. Application Data
(60) Provisional application No. 63/676,895, filed on Jul. 29, 2024.

(51) Int. Cl. C25B 3/26; C25B 3/07; C25B 11/085; C25B 15/08

(52) U.S. Cl. CPC C25B 3/26; C25B 3/07; C25B 11/085; C25B 15/08

(57) ABSTRACT

A method for electrochemically converting carbon dioxide (CO₂) to methanol in an acidic electrolyte environment (pH<6) is provided. The method involves the use of an electrochemical cell equipped with a cathode modified by a metal phthalocyanine-based molecular catalyst that is functionalized with covalently attached cationic iminium groups. These functional groups create a hydrophobic and aerophilic interface that enhances local carbon monoxide (CO) availability at the catalyst surface while simultaneously suppressing the competing hydrogen evolution reaction (HER). By applying an appropriate electrical potential, the electrochemical cell effectively performs selective and efficient CO₂-to-methanol conversion under strongly acidic conditions.

### CROSS-REFERENCE TO RELATED APPLICATIONS

The present application claims priority from U.S. Provisional Utility Patent application No. 63/676,895 filed Jul. 29, 2024; the disclosure of which is incorporated herein by reference in its entirety.

### FIELD OF THE INVENTION

The present invention generally relates to the technical field of electrochemical reaction processes; and specifically relates to the electrocatalysis process in the production of methanol by CO₂ reduction.

### BACKGROUND OF THE INVENTION

Electrocatalytic reduction of carbon dioxide (CO₂), especially when powered by renewable energy sources, presents a compelling pathway for synthesizing value-added fuels while simultaneously addressing pressing environmental concerns. Over the years, various electrocatalysts have been developed to convert CO₂ into chemical products. However, most catalysts primarily yield two-electron-reduced species such as carbon monoxide (CO) and formate. The selective production of more highly reduced compounds, such as methanol (CH₃OH), methane, and ethylene, remains a significant challenge. Among these, methanol is especially attractive due to its high volumetric energy density, liquid phase stability, and utility as a hydrogen carrier. Nonetheless, the direct electrochemical conversion of CO₂ to methanol involves a six-electron transfer process that suffers from sluggish kinetics, leading to poor selectivity, high overpotential, and low current density.

To address these limitations, researchers have explored a range of catalytic materials, including metal complexes, single-atom catalysts, metal oxides, and metal alloys, with varying degrees of success in facilitating methanol electrosynthesis. Molecular catalysts, particularly cobalt phthalocyanine (CoPc), have garnered considerable attention due to their well-defined coordination environments and structural tunability, which promote C₁-selective reduction. For instance, in 2019, it was demonstrated that CoPc uniformly dispersed on multi-walled carbon nanotubes (MWCNTs) enabled effective CO₂-to-methanol conversion by enhancing multi-electron transfer processes. Subsequent studies have further investigated both CO₂ and CO reduction to methanol using CoPc-based catalysts. Current mechanistic understanding suggests that methanol production to proceed through key intermediates such as *CO and *CHO, with the hydrogenation of adsorbed CO (*CO) to formyl (*CHO) identified as the rate-limiting step. However, this pathway is complicated by competing phenomena, including CO₂ re-adsorption, CO desorption, and the hydrogen evolution reaction (HER). While HER can be partially mitigated by operating in neutral or alkaline electrolytes, these conditions often result in carbonate formation and significant carbon loss. Notably, electrolyte regeneration can account for as much as 55% of the overall process cost. Cascade catalysis, wherein CO₂-to-CO and CO-to-methanol reactions occur in tandem or in separate stages, has also been proposed to enhance methanol selectivity (see FIG. 1A). Yet, such approaches necessitate additional steps for intermediate separation and system integration, which increase capital and operational expenditures. Overall, both direct and cascade strategies for methanol electrosynthesis remain constrained by low partial current densities, typically below 50 mA cm⁻².

Acidic electrolytes offer a promising alternative by preventing carbonate formation and enhancing CO₂ utilization. However, the high proton concentration in acidic media tends to exacerbate HER, reducing methanol selectivity. To overcome this limitation, two main strategies have emerged to restrict hydronium ion availability at the catalytic interface. One approach involves introducing concentrated alkali cations into acidic electrolytes. For example, Hu et al. reported that hydrated potassium ions (K⁺) can modulate the local electric field, thereby limiting hydronium migration toward the cathode and suppressing HER. Nevertheless, this shielding effect diminishes at high overpotentials due to the electrostatic breakdown of the K⁺ hydration shell. Another approach employs hydrophobic surface modifications to deter hydronium and water diffusion toward the catalyst. While effective at reducing HER, this method often compromises electrode conductivity and mass transport, limiting its practical applications.

Accordingly, the present invention addresses these challenges by providing a novel and efficient method for conducting electrochemical reactions in strongly acidic media, facilitating selective CO₂-to-methanol conversion while suppressing unwanted hydrogen evolution.

### SUMMARY OF THE INVENTION

It is an objective of the present invention to provide the method, compound, and system to solve the aforementioned technical problems.

In accordance with a first aspect of the present invention, a method for electrochemically reducing CO₂ to methanol in an acidic electrolyte is provided. Specifically, the method includes the following steps: providing an electrochemical cell comprising a cathode, an anode, and an acidic electrolyte having a pH value below 6; disposing a modified molecular catalyst on the cathode, wherein the modified molecular catalyst comprises a metal phthalocyanine functionalized with covalently attached cationic iminium groups; and applying an electrical potential to the electrochemical cell to drive a CO₂-to-methanol conversion at the cathode;

In accordance with one embodiment, the modified molecular catalyst has a hydrophobic and aerophilic interface layer on its surface that promotes local CO availability and suppresses HER.

In accordance with another embodiment, the CO₂-to-methanol conversion achieves a methanol Faradaic efficiency (FE) of at least 60% and a methanol partial current density of at least 130 mA cm⁻².

In accordance with yet another embodiment, the metal phthalocyanine includes one or more of cobalt phthalocyanine (CoPc), nickel phthalocyanine (NiPc), iron phthalocyanine (FePc), and a derivative thereof.

In accordance with yet another embodiment, the cationic iminium groups include alkyl chains having at least 6 carbon atoms.

In accordance with yet another embodiment of the present invention, the alkyl chains include 6 or 10 carbon atoms.

In accordance with yet another embodiment, the hydrophobic and aerophilic interface promotes CO surface coverage through van der Waals interactions and inhibits hydronium ion reduction via electrostatic repulsion.

In accordance with yet another embodiment of the present invention, the applied potential ranges from −1.2 volts to −1.5 volts relative to the potential of a reversible hydrogen electrode (RHE) used as the reference electrode.

In accordance with a second aspect of the present invention, a catalyst for electrochemical CO₂ reduction is introduced. Particularly, the catalyst includes a layered nanosheet framework of a metal phthalocyanine comprising one or more of CoPc, NiPc, FePc and a derivative thereof. The layered nanosheet framework of the metal phthalocyanine is post-synthetically modified with covalently grafted cationic iminium groups having alkyl chains of at least 6 carbon atoms

In accordance with one embodiment, the cationic iminium groups introduce a hydrophobic and aerophilic interface to the surface of the catalyst.

In accordance with another embodiment, the catalyst exhibits suppressed HER activity and enhanced methanol selectivity in an acidic condition.

In accordance with yet another embodiment, the alkyl chains include 6 or 10 carbon atoms.

In accordance with yet another embodiment, the thickness of the layered nanosheet framework of metal phthalocyanine is between 1-2 nm.

In accordance with a third aspect of the present invention, a system for electrochemical conversion of CO₂ to methanol is provided. Specifically, the system includes these components: an electrochemical cell having a cathode coated with the aforementioned catalyst, an anode, and a liquid electrolyte with a pH below 6; a gas feed configured to supply CO₂ to the cathode compartment; and a power source configured to apply an electric potential between the cathode and anode.

In accordance with one embodiment, the system achieves a methanol partial current density of at least 130 mA cm⁻².

In accordance with another embodiment, the electrochemical operates continuously with stable FE for methanol exceeding 60%.

### BRIEF DESCRIPTION OF THE DRAWINGS

Embodiments of the invention are described in more details hereinafter with reference to the drawings, in which:

FIGS. 1A-1C depict systems for molecular multielectron CO₂ reduction, in which FIG. 1A shows proposed tandem electrolyzers to resolve the poor selectivity of multielectron CO₂ reduction of previous molecular catalysts; FIG. 1B shows the method of the present invention for direct CO₂-to-methanol conversion by field modulation; and FIG. 1C depicts the comparison of different methods for methanol electrosynthesis using iminium-C6 and reported catalysts via direct or tandem pathways at different pHs;

FIG. 2 depicts a schematic illustration for the synthesis of catalysts;

FIGS. 3A-3F depict the structural characterizations and surface properties of catalysts, in which FIG. 3A presents the TEM image and structure illustration of iminium-C6; FIG. 3B depicts the AFM images of iminium-C6; FIG. 3C illustrates the AFM images of imine; and FIGS. 3D-3F show the N 1s XPS spectra (FIG. 3D), Zeta potential (FIG. 3E) and contact angle measurements (FIG. 3F) for different catalysts;

FIGS. 4A-4C depict the TEM images of imine (FIG. 4A), iminium-C1 (FIG. 4B) and iminium-C10 (FIG. 4C);

FIGS. 5A-5B depict the AFM images of iminium-C1 (FIG. 5A) and iminium-C10 (FIG. 5B);

FIG. 6 depicts the XRD patterns of CoTAPc, imine, iminium-C1, iminium-C6, and iminium-C10;

FIGS. 7A-7D show the EDS mapping of iminium-C6, including the corresponding TEM image (FIG. 7A), carbon distribution (FIG. 7B), nitrogen distribution (FIG. 7C), and cobalt distribution (FIG. 7D);

FIGS. 8A-8D respectively show the FTIR (FIG. 8A), ¹³C NMR spectra (FIG. 8B), Co 2p XPS (FIG. 8C), and UV-vis spectra (FIG. 8D) of CoTAPc, imine, iminium-C1, iminium-C6, and iminium-C10;

FIG. 9 depicts the zeta potential distribution of CoTAPc, imine, iminium-C1, iminium-C6, and iminium-C10;

FIGS. 10A-10E depict the CV curves of CoTAPc (FIG. 10A), imine (FIG. 10B), iminium-C1 (FIG. 10C), iminium-C6 (FIG. 10D), and iminium-C10 (FIG. 10E) in argon-saturated 0.5 M KHCO₃;

FIGS. 11A-11F depicts the electrocatalytic CO₂RR performance in an H-cell using CO₂-saturated 0.5 M KHCO₃ as the electrolyte, in which FIG. 11A shows the LSV curves of CoTAPc, imine, iminium-C1, iminium-C6, and iminium-C10; and FIGS. 11B-11F illustrate the chronoamperometric curves of CoTAPc (FIG. 11B), imine (FIG. 11C), iminium-C1 (FIG. 11D), iminium-C6 (FIG. 11E), and iminium-C10 (FIG. 11F);

FIGS. 12A-12E depicts the product distribution of CO₂RR in an H-cell catalyzed by CoTAPc (FIG. 12A), imine (FIG. 12B), iminium-C1 (FIG. 12C), iminium-C6 (FIG. 12D), and iminium-C10 (FIG. 12E);

FIGS. 13A-13H depict the electrocatalytic CO₂RR performance, in which FIGS. 13A-13C illustrate the FE_{CH3OH} (FIG. 13A), j_{CH3OH} (FIG. 13B), and Tafel slope (FIG. 13C) in CO₂-saturated 0.5 M KHCO₃ using an H-cell; FIG. 13D is a scheme of flow cell using acidic electrolyte; FIG. 13E and FIG. 13F show the FE_{CH3OH} (FIG. 13E) and j_{CH3OH} (FIG. 13F) in an acidic flow cell using 3.0 M KCl and 0.05 M H₂SO₄ as the electrolyte; FIG. 13G depicts the ¹H NMR spectra of products using ¹²CO₂ and ¹³CO₂ in 3.0 M KCl and 0.05 M H₂SO₄; and FIG. 3H depicts the comparison of maximum FE_{CH3OH} and j_{CH3OH} via CO₂RR and CORR for iminium-C6 at different pHs;

FIG. 14 depicts the EIS Nyquist plots of CoTAPc, imine, iminium-C1, iminium-C6, and iminium-C10 measured at −0.2 V;

FIGS. 15A-15F depicts the electrocatalytic CO₂RR performance in an acidic flow cell, in which FIG. 15A shows the LSV curves of CoTAPc, imine, iminium-C1, iminium-C6, and iminium-C10; and FIGS. 15B-15F show the chronoamperometric curves of CoTAPc (FIG. 15B), imine (FIG. 15C), iminium-C1 (FIG. 15D), iminium-C6 (FIG. 15E), and iminium-C10 (FIG. 15F).

FIGS. 16A-16E depict the product distribution of CO₂RR in an acidic flow cell catalyzed by CoTAPc (FIG. 16A), imine (FIG. 16B), iminium-C1 (FIG. 16C), iminium-C6 (FIG. 16D), and iminium-C10 (FIG. 16E);

FIG. 17 depicts the CO₂RR stability test of iminium-C6 toward in an acidic flow cell;

FIGS. 18A-18B depict the characterizations of catalysts before and after stability tests, in which FIG. 18A and FIG. 18B respectively show the UV-vis spectra and Co 2p XPS spectra of iminium-C6 before and after CO₂ electrolysis in acidic flow cell;

FIGS. 19A-19B depict the electrocatalytic CO₂RR performance in an alkaline flow cell, in which FIG. 19A shows the j_{CH3OH} and FIG. 19B illustrates the FE_{CH3OH} catalyzed by CoTAPc, imine, iminium-C1, iminium-C6, and iminium-C10;

FIGS. 20A-20F depict the electrocatalytic CO₂RR performance in an alkaline flow cell, in which FIG. 20A shows the LSV curves of CoTAPc, imine, iminium-C1, iminium-C6, and iminium-C10; and FIGS. 20B-20F depict the chronoamperometric curves of CoTAPc (FIG. 20B), imine (FIG. 20C), iminium-C1 (FIG. 20D), iminium-C6 (FIG. 20E), and iminium-C10 (FIG. 20F);

FIGS. 21A-21E depict the product distribution of CO₂RR in an alkaline flow cell catalyzed by CoTAPc (FIG. 21A), imine (FIG. 21B), iminium-C1 (FIG. 21C), iminium-C6 (FIG. 21D), and iminium-C10 (FIG. 21E);

FIGS. 22A-22B depict the electrocatalytic CORR performance in an H-cell using 0.5 M KHCO₃ as the electrolyte, in which FIG. 22A shows the j_{CH3OH} and FIG. 22B illustrates the FE_{CH3OH} catalyzed by CoTAPc, imine, iminium-C1, iminium-C6, and iminium-C10;

FIGS. 23A-23F depict the electrocatalytic CORR performance in an H-cell, in which FIG. 23A depicts the LSV curves of CoTAPc, imine, iminium-C1, iminium-C6, and iminium-C10; and FIG. 23B-23F illustrate the chronoamperometric curves of CoTAPc (FIG. 23B), imine (FIG. 23C), iminium-C1 (FIG. 23D), iminium-C6 (FIG. 23E), and iminium-C10 (FIG. 23F);

FIGS. 24A-24E depict the product distribution of CORR in an H-cell catalyzed by CoTAPc (FIG. 24A), imine (FIG. 24B), iminium-C1 (FIG. 24C), iminium-C6 (FIG. 24D), and iminium-C10 (FIG. 24E);

FIGS. 25A-25B depict the electrocatalytic CORR performance in an acidic flow cell, in which FIG. 25A shows the j_{CH3OH} and FIG. 25B illustrates the FE_{CH3OH} catalyzed by COTAPc, imine, iminium-C1, iminium-C6, and iminium-C10;

FIGS. 26A-26F depict the electrocatalytic CORR performance in an acidic flow cell, in which FIG. 26A shows the LSV curves of CoTAPc, imine, iminium-C1, iminium-C6, and iminium-C10; and FIGS. 26B-26F respectively illustrate the chronoamperometric curves of CoTAPc (FIG. 26B), imine (FIG. 26C), iminium-C1 (FIG. 26D), iminium-C6 (FIG. 26E), and iminium-C10 (FIG. 26F);

FIGS. 27A-27E depict the product distribution of CORR in an acidic flow cell catalyzed by CoTAPc (FIG. 27A), imine (FIG. 27B), iminium-C1 (FIG. 27C), iminium-C6 (FIG. 27D), and iminium-C10 (FIG. 27E);

FIGS. 28A-28B depict the electrocatalytic CORR performance in an alkaline flow cell, in which FIG. 28A shows the FE_{CH3OH} and FIG. 28B illustrates the j_{CH3OH} catalyzed by CoTAPc, imine, iminium-C1, iminium-C6, and iminium-C10;

FIGS. 29A-29F depict the electrocatalytic CORR performance in an alkaline flow cell, in which FIG. 29A illustrates the LSV curves of CoTAPc, imine, iminium-C1, iminium-C6, and iminium-C10; and FIGS. 29B-29F respectively depict the chronoamperometric curves of CoTAPc (FIG. 29B), imine (FIG. 29C), iminium-C1 (FIG. 29D), iminium-C6 (FIG. 29E), and iminium-C10 (FIG. 29F);

FIGS. 30A-30E depict the product distribution of CORR in an alkaline flow cell catalyzed by CoTAPc (FIG. 30A), imine (FIG. 30B), iminium-C1 (FIG. 30C), iminium-C6 (FIG. 30D), and iminium-C10 (FIG. 30E);

FIG. 31 depicts the comparison of CO₂-to-methanol conversion by different catalysts in different pHs;

FIGS. 32A-32J depict the experimental investigation of catalyst surface properties, in which FIG. 32A and FIG. 32B show the in situ ATR-SEIRAS spectra of interfacial water at varying potentials for CoTAPc (FIG. 32A) and iminium-C6 (FIG. 32B) in CO₂-saturated 0.5 M K₂SO₄+0.05 M H₂SO₄ with the percentages denoting the content ratio of weakly hydrogen-bonded water; FIG. 32C illustrates the proportion of strongly and weakly hydrogen-bonded water; FIG. 32D shows the rotating-disk electrode voltammetry in argon-saturated 0.5 M K₂SO₄+0.05 M H₂SO₄ at 600 rpm; FIG. 32E and FIG. 32F depict the in situ ATR-SEIRAS spectra of CO₂RR process for CoTAPc (FIG. 32E) and iminium-C6 (FIG. 32F) in CO₂-saturated 0.5 M K₂SO₄+0.05 M H₂SO₄; FIG. 32G shows the iminium-C6 in CO₂-saturated 0.5 M K₂SO₄+0.05 M D₂SO₄ with D₂O as the solvent; FIG. 32H illustrates the Area_{*CHO}/Area_{*CO} ratio at varying potentials; FIG. 32I shows the cyclic voltammetry of Pt disk electrode in a series of CO-saturated 5 mM pyridinium-based electrolytes at 300 rpm; and FIG. 32J depicts the anodic charges from integrated areas in FIG. 32I;

FIGS. 33A-33B depict the in situ ATR-SEIRAS spectra recorded on iminium-C1 (FIG. 33A) and iminium-C10 (FIG. 33B) in CO₂-saturated 0.5 M K₂SO₄+0.05 M H₂SO₄;

FIG. 34 depicts the proportion of medially hydrogen-bonded water calculated from in situ ATR-SEIRAS;

FIGS. 35A-35C depict the O—H vibrations of weakly (FIG. 35A), medially (FIG. 35B), and strongly (FIG. 35C) hydrogen-bonded water for CoTAPc, iminium-C1, iminium-C6, and iminium-C10 in CO₂-saturated 0.5 M K₂SO₄+0.05 M H₂SO₄;

FIGS. 36A-36B respectively depict the LSV curves for CoTAPc, imine, iminium-C1, iminium-C6, and iminium-C10 in argon-saturated 0.5 M K₂SO₄ (FIG. 36A) and 0.1 M KOH+0.45 M K₂SO₄ (FIG. 36B) at a rotating speed of 600 rpm;

FIGS. 37A-37B depict the in situ ATR-SEIRAS of CO₂RR process for iminium-C1 (FIG. 37A) and iminium-C10 (FIG. 37B) in CO₂-saturated 0.5 M K₂SO₄+0.05 M H₂SO₄;

FIG. 38 depict the in situ ATR-SEIRAS of CO₂RR process for iminium-C6 in CO₂-saturated 0.5 M KHCO₃;

FIGS. 39A-39B depict the integrated *CO (FIG. 39A) and *CHO area (FIG. 39B);

FIGS. 40A-40F depict the molecular dynamics simulations of interfaces, in which FIG. 40A illustrates the model for simulation, including 1 molecule, 500 H₂O, 5 H₃O⁺, and 9 Cl⁻ for charge neutralization; FIG. 40B and 40C show the radical distribution functions of H₂O (FIG. 40B) and c H₃O⁺ (FIG. 40C); FIG. 40D depicts the diffusion coefficient of H₃O⁺ calculated from 2-Phase Thermodynamics; FIG. 40E shows the radical distribution function of CO; and FIG. 40F depicts the entropy and free energy of CO calculated from 2-Phase Thermodynamics;

FIGS. 41A-41E depict the electrocatalytic performance of NiTAPc and derived iminium-C6 (Ni), in which FIG. 41A illustrates the LSV curves; FIG. 41B shows the FE_{CO}; FIG. 41C shows the j_{CO} of NiTAPc and iminium-C6 (Ni) for CO₂RR in an acidic flow cell; FIG. 41D and FIG. 41E depict the chronoamperometric curves of NiTAPc (FIG. 41D) and iminium-C6 (Ni) (FIG. 41E);

FIG. 42 depicts the LSV curves for NiTAPc and iminium-C6 (Ni) in argon-saturated 0.5 M K₂SO₄+0.005 M H₂SO₄ at a rotating speed of 600 rpm; and

FIG. 43 depicts the cyclic voltammetry of Pt disk electrode in a series of argon-saturated 5 mM pyridinium-based electrolytes at a rotating speed of 300 rpm.

### DETAILED DESCRIPTION

In the following description, systems, compounds and methods for performing electrochemical reactions in a strong acidic medium, including conducting methanol electrosynthesis using multielectron molecular CO₂ reduction reaction (CO₂RR) and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Selective, multielectron, molecular CO₂RR in strong acid is challenged by the scarcity of catalyst candidates, competitive hydrogen evolution, and slow product formation. Consequently, molecular CO₂RR is typically conducted in neutral or alkaline environments to improve performance, inevitably causing significant carbon loss and increased operational cost.

As used herein, the term “local CO availability” refers to the concentration and retention of CO molecules in the immediate vicinity of the electrocatalyst's active sites during electrochemical CO₂ reduction. It reflects how effectively CO—either as an intermediate or a feedstock—is maintained near the catalyst surface, enabling subsequent reactions (e.g., CO-to-methanol conversion) to proceed efficiently.

In accordance with a first aspect of the present invention, a method for electrochemically reducing CO₂ to methanol in an acidic electrolyte is provided. Specifically, the method utilizes a modified molecular catalyst engineered to overcome traditional limitations associated with acidic CO₂ reduction. In the method, an electrochemical cell is employed, which includes a cathode, an anode, and an electrolyte medium with a pH value below 6. This acidic environment, although historically challenging due to the dominance of HER, is here transformed into a suitable medium for selective CO₂-to-methanol conversion by virtue of the uniquely designed catalyst.

A key feature of the method lies in the use of a modified molecular catalyst that is immobilized on the cathode surface. The catalyst includes a metal phthalocyanine—such as CoPc, NiPc, FePc, or their derivatives—which is further functionalized with covalently attached cationic iminium groups. These iminium groups carry long alkyl side chains, preferably of six or ten carbon atoms in length. The covalent incorporation of these cationic moieties imparts a dual effect: electrostatic repulsion to inhibit hydronium ion (H₃O⁺) reduction, and enhanced van der Waals interactions that facilitate CO retention near the active site.

Upon the application of an appropriate electrical potential—specifically in the range from −1.2 V to −1.5 V relative to the potential of a RHE used as the reference electrode—the modified molecular catalyst enables the electrochemical reduction of CO₂ to proceed efficiently. The hydrophobic and acrophilic interface created by the long-chain iminium groups serves to locally concentrate CO, a key intermediate, by increasing its surface coverage and availability for further reduction. Simultaneously, this interface repels hydronium ions, effectively suppressing the competing HER and thus improving the reaction's selectivity for methanol.

It is worth noting that the method achieves notable performance metrics. The CO₂-to-methanol conversion attains a methanol FE of at least 60%, and a methanol partial current density (j_{CH}_{₃}_{OH}) of no less than 130 mA cm⁻², indicating a highly productive and energy-efficient process. These performance outcomes exceed those of conventional neutral or alkaline CO₂ electroreduction methods, particularly in the context of strong acid media.

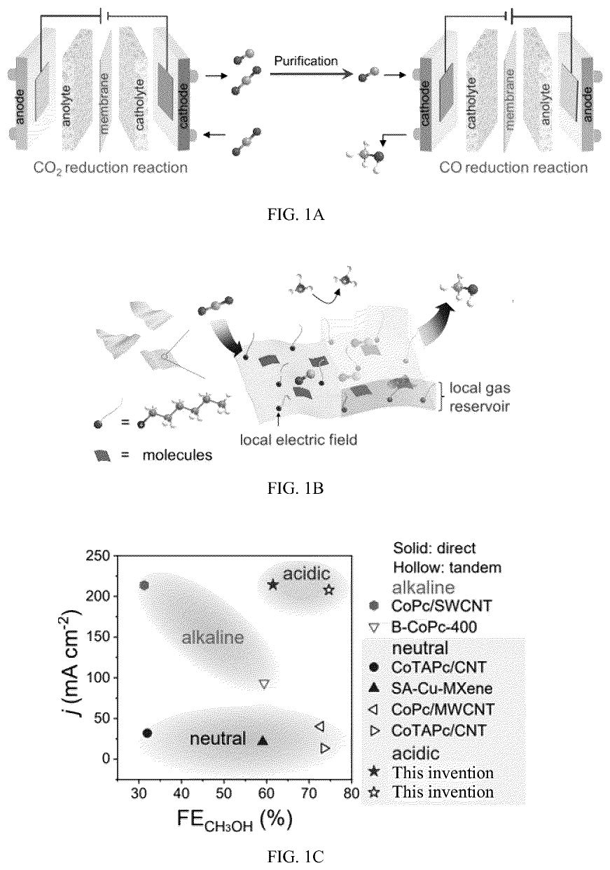

As shown in FIG. 1B, the present invention provides a method for performing electrochemical reactions in a strongly acidic medium, enabling efficient and selective conversion of CO₂ to methanol. A key feature of the method is the modulation of the interfacial environment surrounding molecular electrocatalysts to enhance their activity and selectivity under acidic conditions. In particular, CoPc is immobilized as atomically thin layers, which mitigates aggregation commonly observed at high catalyst loadings and simultaneously improves electronic conductivity and charge transfer.

To further enhance catalytic performance, the CoPc layers are post-synthetically modified with covalently tethered cationic iminium functional groups positioned in close proximity to the cobalt active sites. These cationic moieties serve to intensify the local electric field at the catalyst-electrolyte interface, effectively suppressing the HER and expanding the electrochemical operating window. Additionally, by tuning the alkyl chain length of the cationic substituents, the hydrophobicity and aerophilicity of the interfacial environment are precisely controlled. This dual tuning of electrostatic and interfacial properties creates an acrophilic microenvironment that facilitates CO adsorption and retention at the catalyst surface, which is essential for promoting the multistep cascade reduction of CO₂ to methanol.

Unlike conventional hydrophobic coatings, which often impede mass transport, the strategy disclosed in this invention preserves mass transfer in the diffusion layer while functioning as an acrophilic CO reservoir. This integrated approach leads to a significant enhancement in methanol electrosynthesis. Under optimized conditions, a partial current density for methanol production of 131.6 mA cm⁻² and a Faradaic efficiency (FE_{CH3OH}) of 61.5% are achieved in a highly acidic electrolyte (pH≈1) at a potential of −1.37 V versus the RHE. Simultaneously, the Faradaic efficiency for hydrogen evolution (FE_{H2}) is substantially suppressed to 15.7%, compared to 39.1% observed with unmodified CoPc analogs.

This performance surpasses those of most previously reported systems operating in neutral or alkaline conditions (as shown in FIG. 1C). Mechanistic studies using in situ attenuated total reflectance surface-enhanced infrared absorption spectroscopy (ATR-SEIRAS), rotating-disk electrode (RDE) voltammetry, and molecular dynamics (MD) simulations confirm both a reduction in interfacial hydronium activity and an increase in CO surface coverage near the catalyst active sites. Importantly, the approach is generalizable and has been successfully extended to other molecular catalysts, such as nickel phthalocyanine, which under similar acidic conditions favors CO production as the primary product.

In accordance with a second aspect of the present invention, a catalyst for electrochemical CO₂ reduction is provided, characterized by a layered nanosheet framework composed of a metal phthalocyanine. The metal phthalocyanine may include one or more of CoPc, NiPc, FePc, or derivatives thereof. These phthalocyanines are structured into a two-dimensional nanosheet architecture that enables high exposure of catalytic sites and facilitates effective mass and charge transport during electrochemical reactions.

Importantly, the nanosheet framework is post-synthetically modified through covalent grafting of cationic iminium groups onto the phthalocyanine structure. These iminium groups are functionalized with alkyl chains that contain at least six carbon atoms, such as hexyl (C₆) or decyl (C₁₀) chains. The covalent nature of the modification provides structural stability and persistent interfacial functionality throughout prolonged electrolysis operations. The introduction of these long-chain cationic iminium moieties serves multiple purposes: first, the positive charges of the iminium groups alter the local electric field near the catalytic surface, which plays a critical role in modulating interfacial ionic transport; second, the long alkyl chains create a hydrophobic and acrophilic interface that repels hydronium ions and water molecules, while simultaneously enriching the local concentration of CO gas near the active metal centers.

This engineered interfacial microenvironment provides two key functional benefits. Firstly, it effectively suppresses the HER, a major parasitic reaction in acidic CO₂ electroreduction conditions. This suppression is achieved through electrostatic repulsion between the hydrophilic hydronium ions and the cationic, hydrophobic surface, as well as through reduced water dissociation activity. Secondly, the acrophilic properties of the interface promote retention and availability of CO at the catalytic surface, facilitating further hydrogenation steps toward methanol production. These effects together contribute to a substantial improvement in both methanol selectivity and overall catalytic efficiency under acidic conditions, which are typically considered hostile for multielectron CO₂ reduction processes.

In specific embodiments, the alkyl chains on the cationic iminium groups may include exactly six or ten carbon atoms, corresponding to hexyl or decyl groups, respectively. These particular chain lengths have been evidenced to optimize the balance between hydrophobicity and structural accessibility, thus maximizing the desired interfacial effects. Furthermore, the thickness of the layered nanosheet framework of the metal phthalocyanine catalyst is maintained in the range of 1 to 2 nanometers. The ultrathin morphology provides a high surface-area-to-volume ratio and minimizes resistance to electron and mass transfer during electrocatalysis. Collectively, these features result in a highly active and selective catalyst system for the electrochemical conversion of CO₂ to methanol in acidic media.

In accordance with a third aspect, the present invention further provides a system for electrochemical conversion of CO₂ to methanol, designed to operate efficiently in acidic environments. The system has an electrochemical cell that includes a cathode, an anode, and a liquid electrolyte, wherein the electrolyte has a pH value below 6, indicative of a strongly acidic condition. The cathode in this electrochemical cell is coated with the aforementioned catalyst.

The system includes a gas feed module configured to deliver CO₂ directly to the cathode compartment, providing a continuous and adequate supply of reactant gas. This configuration enables consistent interfacial gas concentration at the catalytic surface and sustains high-performance operation throughout the electrolysis process. In addition, the system is equipped with a power source capable of applying an electrical potential across the cathode and anode sufficient to drive the electrochemical reduction of CO₂ to methanol. In exemplary implementations, this potential is typically in the range of −1.2 V to −1.5 V vs. RHE, which is effective for initiating and sustaining CO₂-to-methanol conversion in acidic media.

With this system design, a methanol partial current density of at least 130 mA cm⁻² is achieved, representing a substantial advancement in the field of acidic CO₂ electroreduction. Furthermore, the system is capable of continuous operation while maintaining a FE for methanol production that exceeds 60%. Such performance metrics indicate not only high activity and selectivity of the catalyst, but also the robustness and operational stability of the overall electrochemical configuration, making it highly suitable for scalable CO₂-to-methanol conversion applications under industrially relevant conditions.

### EXAMPLES

In the following examples, transmission electron microscopy (TEM) images are taken on a Philips™ Technai 12 with an accelerating voltage of 120 kV and a JEOL™ JEM-2100F equipped with EDS detector at an accelerating voltage of 200 kV. Atomic force microscopy (AFM) images are performed on Bruker™ Icon in tapping mode. Fourier transform infrared (FT-IR) spectroscopy is measured using KBr pellets on a Perkin Elmer™ Spectrum 100 spectrometer in the range of 500-4000 cm⁻¹. Solid state 13C nuclear magnetic resonance (13C NMR) spectra are measured on Bruker™ Avance III 500. The elemental composition of catalysts is analyzed by X-ray photoelectron spectroscopy (XPS) on a Thermo Fisher Scientific™ K-Alpha equipped with an Al X-ray excitation source (1486.6 eV). All binding energies are referenced to the C1s peak at 284.8 eV. UV-Vis spectra are measured on Shimadzu™ UV1700. Zeta potentials are recorded on a dynamic light scattering particle size analyzer (Malvern Panalytical™ Zetasizer Nano-ZS).

Faradaic efficiency: The Faradic efficiency for CH₃OH production is calculated according to:

$$E = \frac{{j}_{CH 3 OH}}{{j}_{total}} = \frac{N * F * {n}_{CH 3 OH}}{{j}_{total} * t} * 100 \%$$

j_{CH3OH} is the partial current density for CH₃OH formation, jₜₒₜₐₗ is the total current, N is the number of electrons required to form CH₃OH (N=6 for CO₂ feed, N=4 for CO feed), F is the Faraday constant (F=96485 C mol⁻¹), n_{CH3OH} is the moles of produced CH₃OH, and t is the time(s).

All molecular dynamics calculations are performed using the LAMMPS software. All covalent terms (i.e., bonds, angles, and dihedrals) are described using the Universal Force Field (UFF) potential. Van der Waals interactions are also described using UFF. Atomic charges are computed using the Charge Equilibrium (QEq) scheme by Rappe and Goddard. Modified QEq parameters are used to describe the charged N⁺ species and the H and O atoms of charged H₃O⁺ species.

Specifically, the QEq electronegativities of the N⁺ and H₃O⁺ atoms are modified to allow charge accumulation of +0.6 on the ions, in line with charges predicted from Mulliken analyses. All catalysts are surrounded by 500 water molecules. 5 H₃O⁺ are then solvated, followed by 9 Cl⁻ ions (in order to restrict the total system charge to 0). All species are randomly spawned using Packmol to avoid bias. The systems are first minimized, followed by heating from 0.1 to 298.15 K using the canonical (NVT) ensemble. The systems are then maintained at 298.15 K for 2 ns. Volumes are chosen such that the system densities are equal to that of liquid water.

### Example 1. Catalyst Synthesis and Characterizations

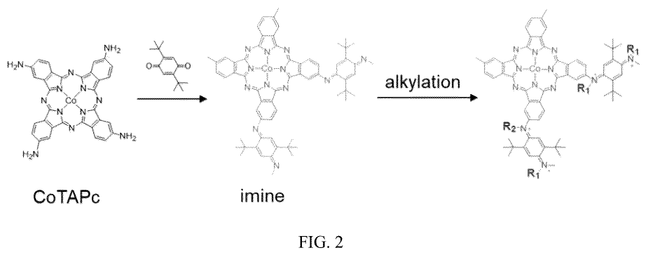

Cationic nanosheets are synthesized through a two-step process involving the initial condensation of cobalt tetraaminophthalocyanine (CoTAPc) with 2,5-di-tert-butyl-1,4-benzoquinone (DTBBQ), followed by alkylation of the resulting imine-linked nanosheets using alkyl iodides (n-CₓH₂ₓ₊₁I, x=1, 6, 10) to yield the corresponding iminium-functionalized materials, designated as iminium-Cx. As shown in FIG. 2, for iminium-C1, both R₁ and R₂ are CH₃ groups; for iminium-C6, R₁ is n-C₆H₁₁ and R₂ is CH₃; for iminium-C10, R₁ is CH₃ and R₂ is n-C₁₀H₂₁.

In the synthesis of imine, 4 mg of CoTAPc and 20 mg of DTBBQ are dissolved in a mixed solvent system comprising 5 mL of dimethylacetamide (DMAc) and 2 mL of ethanol, to which 0.2 mL of 6 M acetic acid (HAc) is added. This mixture is placed in a 20 mL high-pressure Schlenk tube, sonicated for 10 minutes, and degassed via three cycles of freeze-pump-thaw. The sealed tube is then heated to 120° C. and maintained at that temperature for 72 hours. After cooling to room temperature, ethyl ether is added to precipitate the reaction mixture. Bulk precipitates are removed by centrifugation at 3,000 rpm for 10 minutes. The imine-linked nanosheets are recovered by centrifugation at 10,000 rpm for 30 minutes and subsequently washed three times each with N,N-dimethylformamide (DMF) and ethanol to eliminate any residual impurities. The resulting imine material is dried under vacuum at 60° C. overnight to yield the imine precursor powder.

To prepare iminium-C1, 30 mg of the imine powder is dispersed in 10 mL of DMF in a 25 mL round-bottom flask and sonicated for 10 minutes. Next, 200 μL of methyl iodide is added, and the mixture is stirred at 50° C. for 12 hours. After the reaction, the product is precipitated by the addition of diethyl ether and purified by centrifugation at 12,000 rpm for 30 minutes, followed by washing with ethanol. The final product is freeze-dried to obtain iminium-C1 as a loose powder.

For the synthesis of iminium-C6, 30 mg of the imine powder and 0.2 mL of 1-iodohexane are added to 10 mL of N-methyl-2-pyrrolidone (NMP) in a 50 mL high-pressure Schlenk tube. The mixture is sonicated for 10 minutes and degassed using three freeze-pump-thaw cycles. The sealed tube is heated at 120° C. for three days. Upon completion, the reaction mixture is washed thoroughly with ethyl acetate, and the intermediate product is vacuum-dried at 60° C. To achieve full quaternization, the resulting solid is treated with methyl iodide using the same conditions as described for iminium-C1, yielding iminium-C6.

The synthesis of iminium-C10 follows the same procedure as that of iminium-C6, with the sole difference being the use of 1-iododecane in place of 1-iodohexane as the alkylating agent.

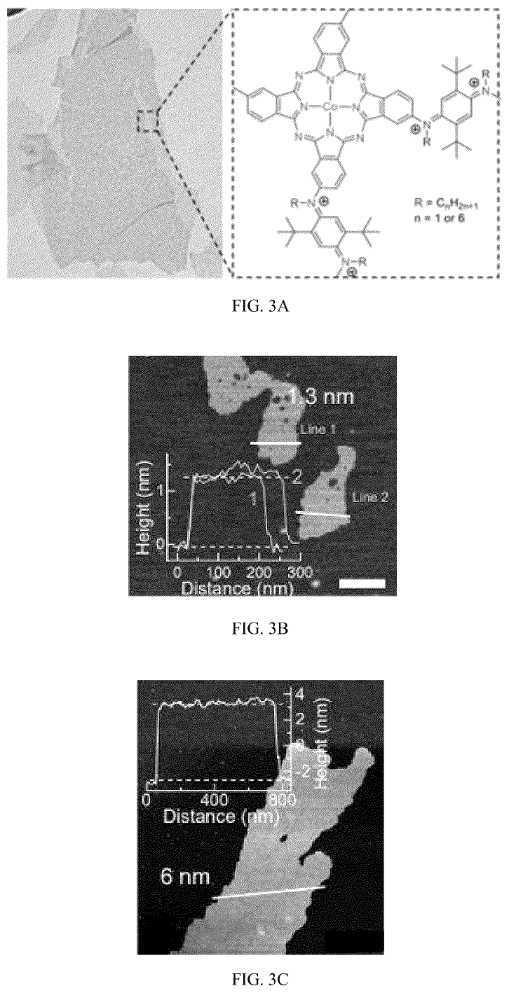

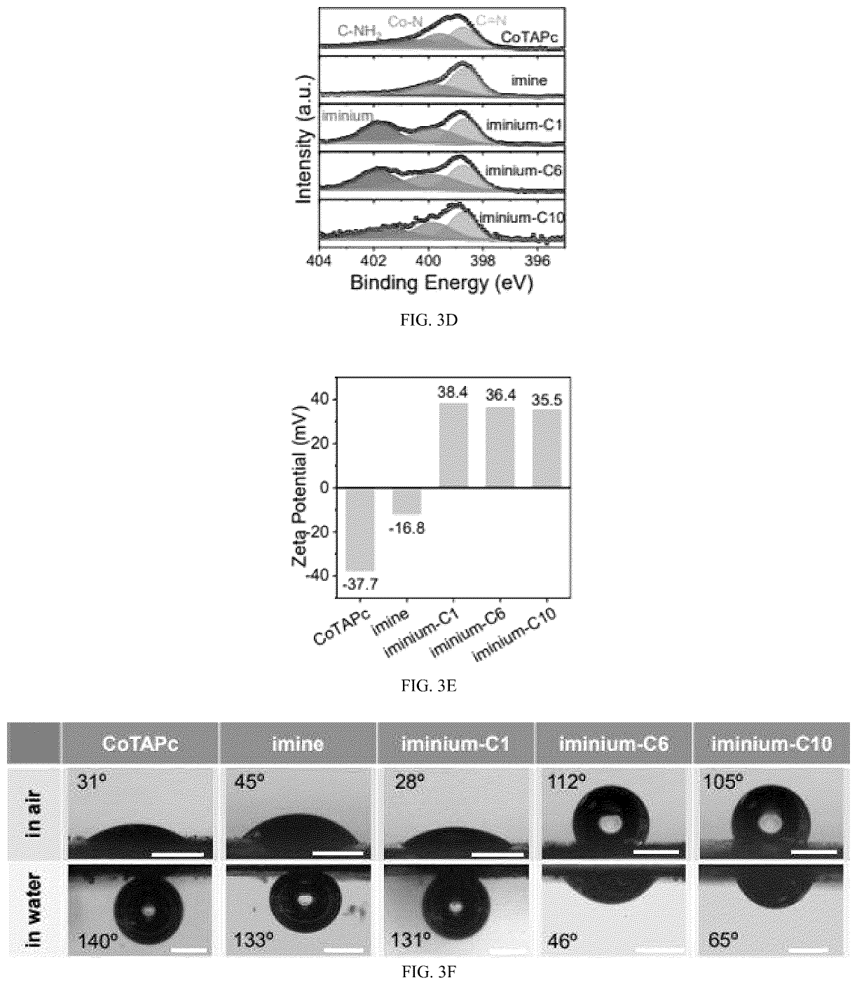

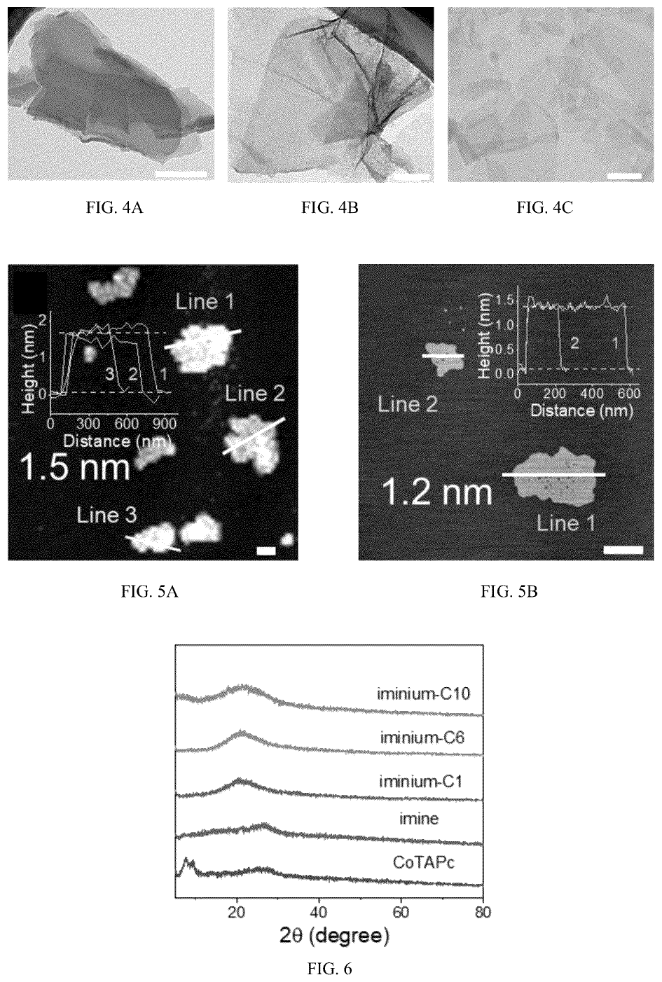

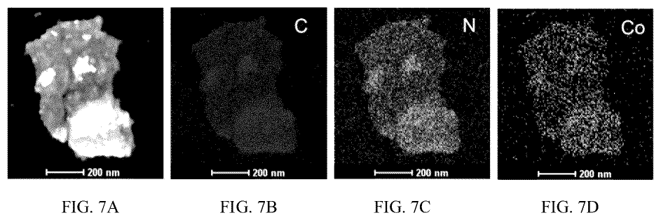

TEM images (FIGS. 3A and 4) confirm the formation of two-dimensional (2D) nanosheet structures in the iminium-functionalized materials. AFM analysis (FIGS. 3B-3C and 5) reveals that the alkylated iminium nanosheets are ultrathin, with a thickness of approximately 1.3 nm, in contrast to the parent imine material, which exhibits a thickness of ˜6 nm. This reduction in thickness is attributed to the incorporation of in-plane cationic charges that facilitate exfoliation and dispersion. Powder X-ray diffraction (XRD) patterns (FIG. 6) demonstrate the amorphous nature of the covalent organic nanosheets. The imine sample shows a broad diffraction peak at 26.4°, while the iminium samples display shifted peaks around 21°, indicating an increase in interlayer spacing. Elemental mapping via energy-dispersive X-ray spectroscopy (EDS) (FIG. 7) confirms the homogeneous distribution of Co atoms across the surface of the iminium-C6 material.

During the synthesis of iminium-C6 and iminium-C10, an additional methylation step is employed to achieve complete conversion of imine to iminium. This is necessary because initial alkylation with bulky hexyl or decyl iodides results in incomplete quaternization due to steric hindrance. For example, XPS N 1s spectra of iminium-C10 show that only approximately 30% of the imine is converted to iminium by decyl iodide alone. Sequential methylation successfully achieves full alkylation. This post-alkylation methylation step also increases the zeta potential of the material from 11.4 mV to 35.5 mV, approaching the value observed for iminium-C1.

Complete conversion of imine to iminium is critical for enhancing electrochemical CO₂ reduction in acidic media, as the cationic charges reduce the availability of interfacial hydronium ions, thereby suppressing the HER. The full alkylation improves the FE_{CH3OH} from 32% to 54%, and concurrently increases the methanol partial current density (j_{CH3OH}) from 54 mA cm⁻² to 115 mA cm⁻².

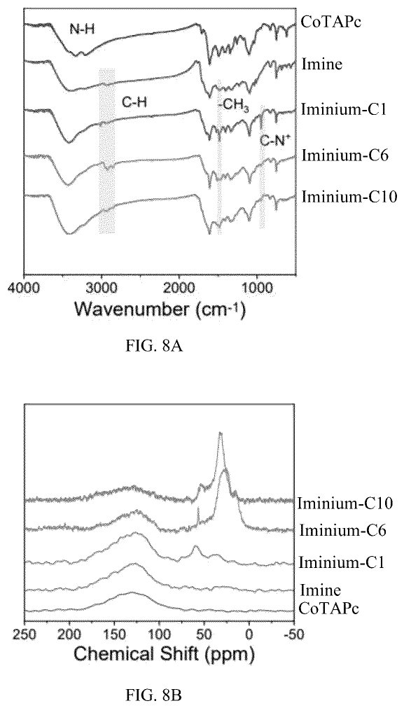

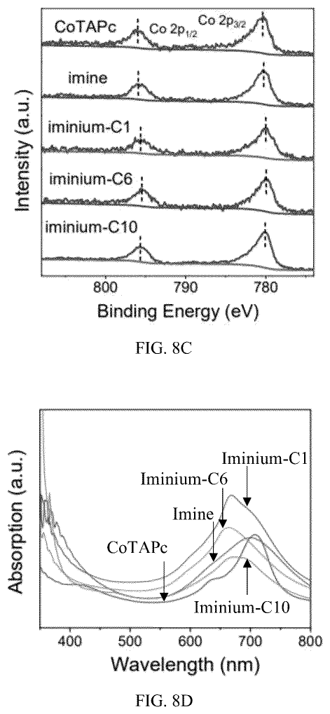

The chemical structures of the synthesized catalysts are characterized using FT-IR, solid-state ¹³C nuclear magnetic resonance spectroscopy (¹³C NMR), and XPS. As shown in FIG. 8A, FT-IR spectra of CoTAPc exhibit characteristic phthalocyanine vibrations at 1709, 1608, 1490, 1341, 1261, 825, and 750 cm⁻¹, and N—H stretching modes at 3324 and 3206 cm⁻¹. The disappearance of these N—H signals and the emergence of a peak at 1655 cm⁻¹, corresponding to the imine stretch, confirm the formation of imine linkages. In the iminium samples, new peaks at 945 and 1479 cm⁻¹ are observed, corresponding to the C—N⁺ stretching and alkyl group bending modes, respectively. Additionally, the stronger C—H stretch signals at 2922 and 2869 cm⁻¹ in iminium-C6 and iminium-C10 confirm successful alkyl chain incorporation.

The ¹³C NMR spectra (FIG. 8B) show broad resonances due to the paramagnetic Co center, along with distinct peaks at 59 ppm (iminium-C1), 56.1 ppm (iminium-C6), and 53.4 ppm (iminium-C10), which are assigned to the alkyl chains. XPS analysis of N 1s spectra (FIG. 3D) reveals a peak at 401.8 eV for iminium nitrogen. Deconvolution indicates an approximate 1:1:1 ratio of iminium, pyrrolic, and pyridinic nitrogen species, confirming nearly complete conversion of imine to iminium. The Co 2p spectra (FIG. 8C) of the iminium samples show binding energy shifts to lower values compared with pristine CoTAPc (Co 2p_{3/2} at 780.4 cV and Co 2p_{1/2} at 795.9 eV), due to the electron-withdrawing nature of the iminium groups.

UV-Vis spectroscopy (FIG. 8D) indicates a blue shift in the Q band for the iminium samples compared to CoTAPc and imine, further supporting the electron-deficient environment induced by iminium functionalization.

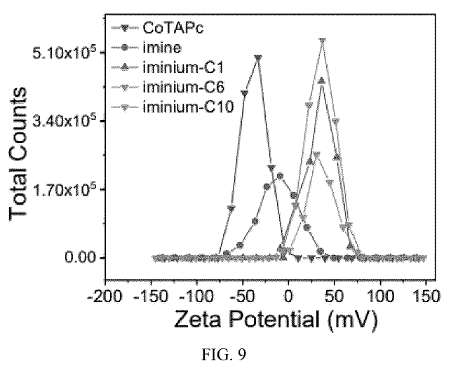

The surface ionic characteristics of the materials were first evaluated by measuring their zeta potentials (FIG. 3E and FIG. 9). The measured zeta potential values for CoTAPc, imine, iminium-C1, iminium-C6, and iminium-C10 are −37.7 mV, −16.8 mV, 38.4 mV, 36.4 mV, and 35.5 mV, respectively, confirming the successful conversion to cationic iminium structures and their positively charged surface nature. To assess the hydrophobic and aerophilic properties of the materials, static water contact angles are measured (FIG. 3F). CoTAPc and imine exhibit hydrophilic behavior, with water contact angles of 31° and 45°, respectively. In contrast, iminium-C6 and iminium-C10 demonstrate markedly increased hydrophobicity, with water contact angles of 112° and 105°, respectively.

To further evaluate the materials' affinity for gaseous CO₂, CO₂ contact angles are measured by immersing the catalyst films in water and observing their interactions with CO₂ bubbles. CoTAPc and imine are found to be aerophobic, with large CO₂ contact angles of 140° and 133°, indicating poor gas interaction. On the other hand, iminium-C6 and iminium-C10 show significantly lower CO₂ contact angles of 46° and 65°, respectively, confirming their enhanced acrophilicity and gas-wetting properties.

These results demonstrate that by modifying the iminium structure—specifically, through variation in alkyl chain length—it is possible to systematically tune the surface charge, hydrophobicity, and acrophilicity surrounding the catalyst's active site. This tunability provides a strategic handle to modulate interfacial mass transport properties, particularly relevant to CO₂RR, as elaborated in the subsequent sections.

### Example 2. Electrochemical CO₂ Reduction Performance

The electrocatalytic CO₂RR performance is first evaluated in an H-type electrochemical cell using 0.5 M KHCO₃ as the electrolyte.

H-cell configuration for electrochemical CO₂RR measurement: CO₂RR measurements are conducted in a glassy H-type electrochemical cell (Gaoss Union™ C007-10) using 0.5 M KHCO₃ as the electrolyte. The catholyte and anolyte volumes are each maintained at 10 mL. To prepare the working electrode, 10 mg of iminium-C6 catalyst and 10 mg of MWCNTs are individually dispersed in 10 mL of ethanol, referred to as dispersion A and dispersion B, respectively. A mixture of 0.2 mL of dispersion A and 1.0 mL of dispersion B is combined, followed by the addition of 2 μL of 5 wt % Nafion solution. The resulting mixture is ultrasonicated for 30 minutes to obtain a homogeneous catalyst ink. Subsequently, 100 μL of the ink is drop-cast onto a glassy carbon electrode (geometric area=0.5 cm²) and dried at room temperature. A platinum foil and an Ag/AgCl electrode serve as the counter and reference electrodes, respectively.

Prior to electrochemical testing, CO₂ gas (99.99% purity, Linde) is bubbled through the catholyte for 20 minutes to saturate the electrolyte. During the test, CO₂ is continuously supplied to the cathodic chamber at a flow rate of 5 standard cubic centimeters per minute (sccm). Linear sweep voltammetry (LSV) is performed at a scan rate of 50 mV/s. Gascous products are analyzed using online gas chromatography (GC, Shanghai Ruimin Instrument™ GC 2060, Shanghai), while liquid products are quantified using ¹H NMR spectroscopy (Bruker™ AVANCE AV III 300), employing DMSO as the internal standard. For the NMR analysis, 450 μL of the post-reaction electrolyte is mixed with 50 μL of a 10 mM DMSO solution prepared in D₂O.

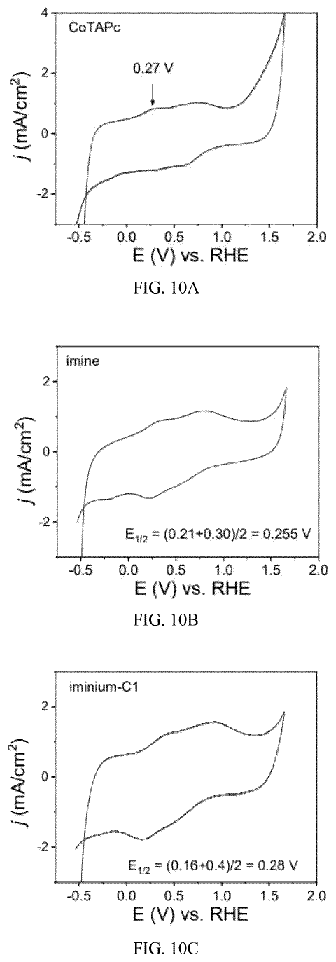

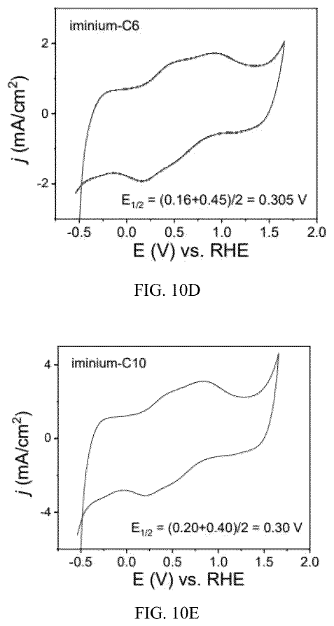

In Ar-saturated conditions (FIGS. 10A-10E), the half-wave potential (E_{1/2}) corresponding to the Co²⁺/Co³⁺ redox couple of iminium-functionalized catalysts shifts positively compared to those of imine and CoTAPc, likely due to the electron-withdrawing nature of the grafted cationic moieties. The integrated charges from the Co⁺/Co^{2 +} oxidation peaks are quantified as 0.18, 0.23, 0.29, 0.35, and 0.30 mC for CoTAPc, imine, iminium-C1, iminium-C6, and iminium-C10, respectively, indicating an increased density of electrocatalytically active sites in the iminium-functionalized systems.

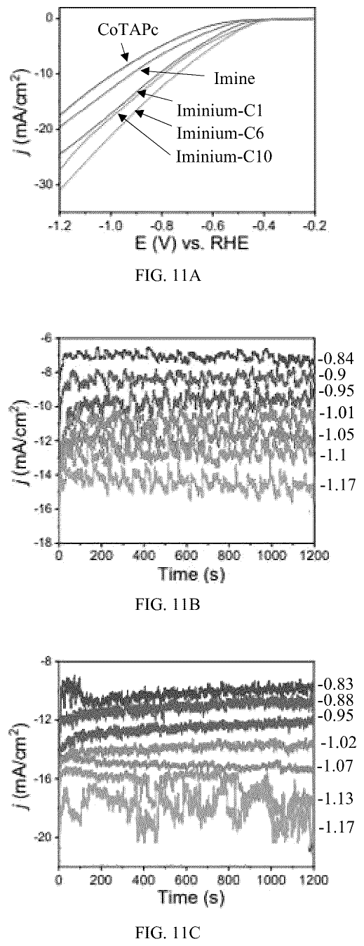

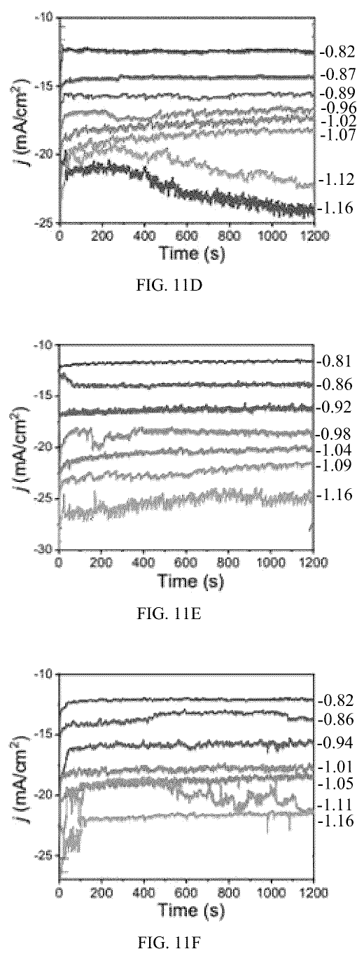

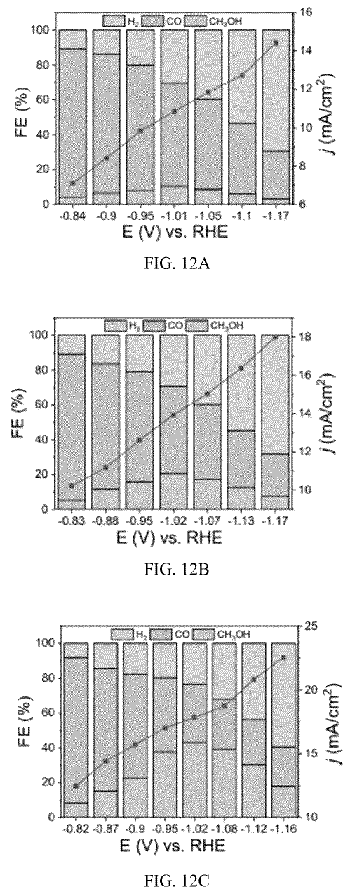

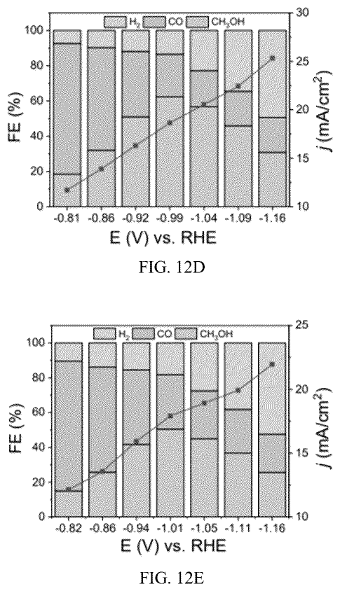

Linear sweep voltammetry (LSV) is conducted in CO₂-saturated electrolyte to compare activity across samples (FIGS. 11 and 12). Among them, iminium-C6 exhibited the most positive onset potential (−0.35 V vs. RHE) and the highest current density in the potential range of −0.4 to −1.2 V. Chronoamperometry tests are subsequently performed, and the gas and liquid-phase products are analyzed using online gas chromatography (GC) and ¹H NMR. Across all samples, the only detectable products are H₂, CO, and CH₃OH. Iminium-C6 achieves the highest j_{CH3OH} of 11.62 mA·cm⁻², a FE_{CH3OH} of 62.3%, and the lowest FE_{H2} of 13.5% at −1.0 V. By contrast, the neutral imine catalyst only reaches a FE_{CH3OH} of 20.4% with an associated FE_{H2} of 29.4% under similar conditions.

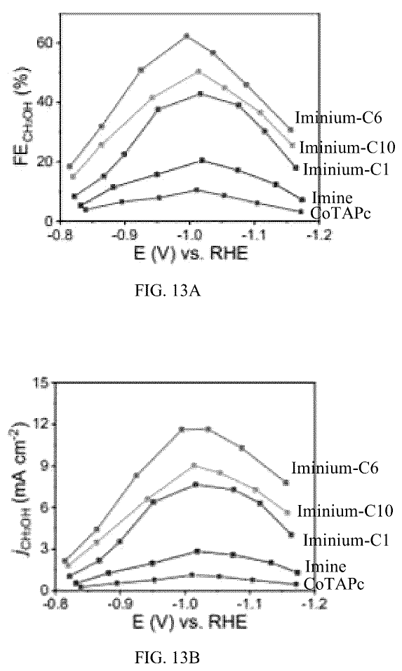

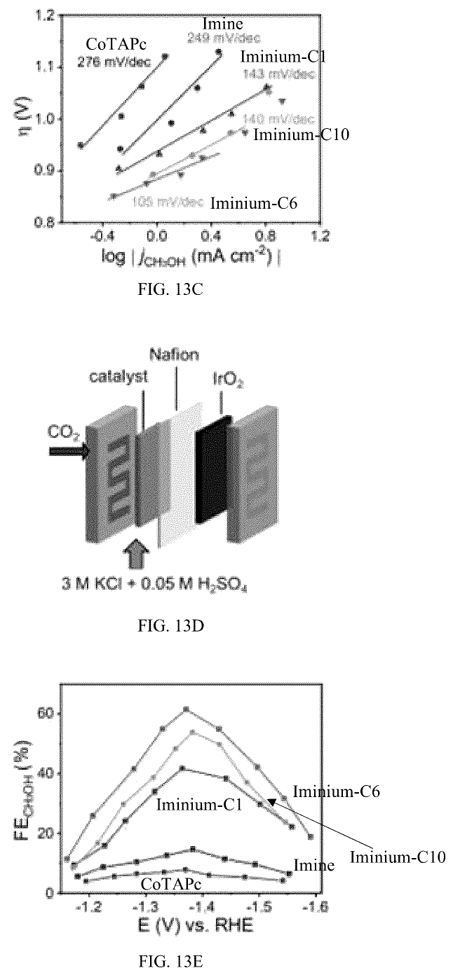

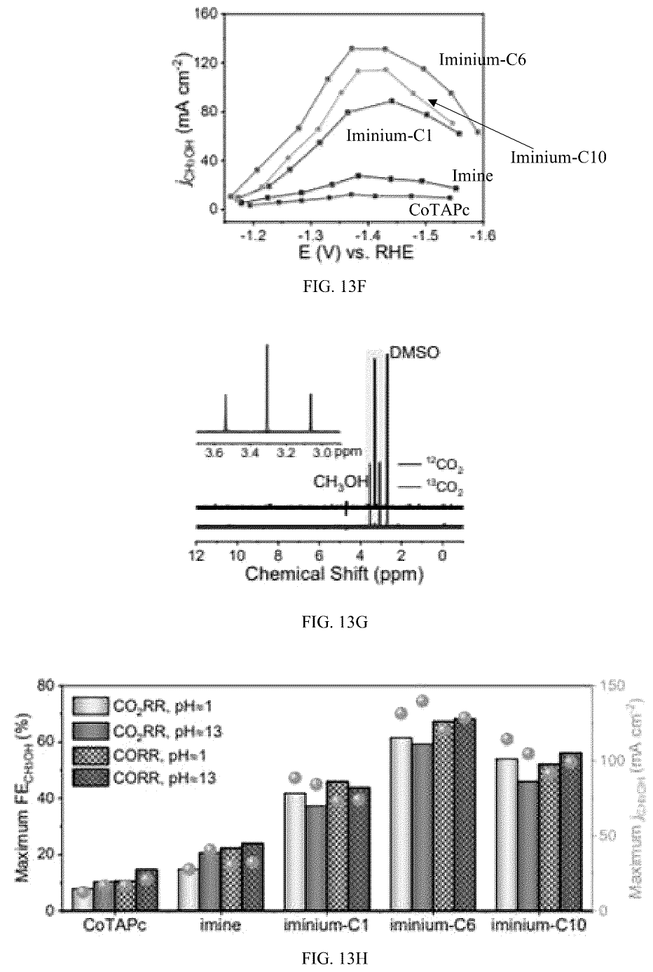

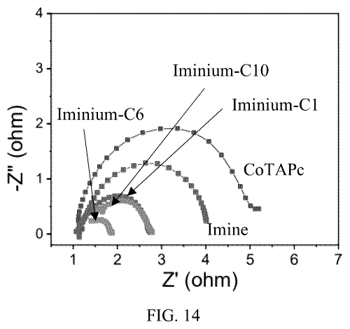

Tafel slope analysis derived from j_{CH3OH} values (FIG. 13) indicates that iminium-C6 has the most favorable reaction kinetics, with a slope of 105 mV·dec⁻¹, lower than those for CoTAPc (276 mV·dec⁻¹), imine (249 mV·dec⁻¹), iminium-C1 (143 mV·dec⁻¹), and iminium-C10 (140 mV·dec⁻¹). This reduced Tafel slope suggests enhanced electron transfer and favorable interfacial mass transport, facilitated by the ultrathin structure of the iminium-C6 layer and its acrophilic interface. Electrochemical impedance spectroscopy (EIS) further supports this observation, with iminium-C6 showing the lowest charge transfer resistance (0.9 Ω), indicative of accelerated electron transport (FIG. 14). The slightly higher Tafel slopes observed for iminium-C1 and iminium-C10 are likely due to decreased surface CO coverage and reduced ionic conductivity, respectively.

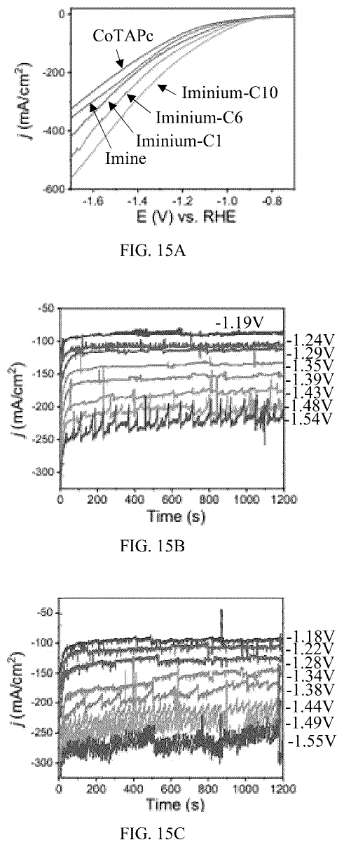

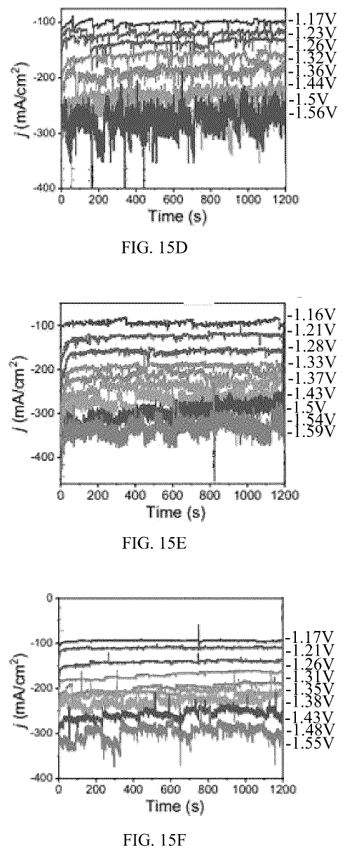

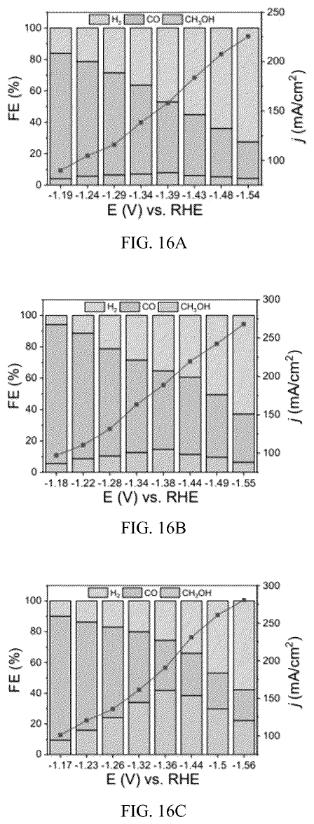

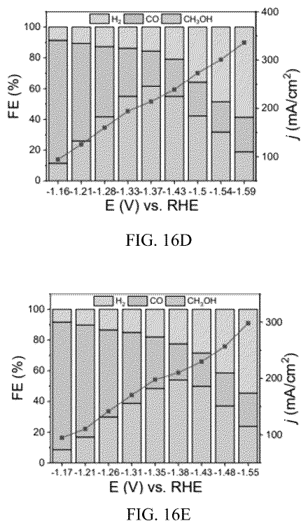

The CO₂ electrolysis performance of the catalysts is also evaluated under acidic conditions (pH≈1) using a flow cell setup (FIGS. 13D-13F, FIGS. 15 and 16). Briefly, for flow cell, the catalyst electrode is fabricated as follows: 2.5 mg catalyst, 2.5 mg carbon black, and 25 μL 5 wt % Nafion solution are mixed in 1 mL ethanol and sonicated for 30 min to form a catalyst ink. This ink is then dip-coated onto a 1×2.5 cm² gas diffusion layer to serve as the working electrodes, with an active area of 0.5×2 cm². The cathode and anode chambers are separated by a proton exchange membrane. The electrolytes are 3 M KCl+0.05 M H₂SO₄. 50 mL catholyte is circulated at a flow rate of 5 mL/min, while the anolyte's flow rate is maintained at 10 mL/min by a peristaltic pump. Gas feeds of CO₂ and CO are introduced from the backside of the gas diffusion layer to the liquid electrolyte with flow rates of 3 sccm and 5 sccm, respectively. The gascous and liquid products in the flow cell are analyzed using the same methods as in the H-type cell. The electrolysis in an alkaline environment is conducted using a mixed solution of 0.2 M KOH+1.5 M KCl, with an anion exchange membrane employed.

The results show that iminium-C6 retains high methanol selectivity in acid, with FE_{CH3OH} increasing with more negative potentials, peaking at 61.5% at −1.37 V (FIG. 13E). In contrast, CoTAPc and imine show poor acid tolerance, with FE_{H2} exceeding 35% at −1.38 V. At −1.37 V, iminium-C6 achieves the highest methanol partial current density of 131.6 mA·cm⁻²—representing enhancements of 538% and 961% over imine (20.7 mA·cm⁻²) and CoTAPc (12.4 mA·cm⁻²), respectively (FIG. 13F).

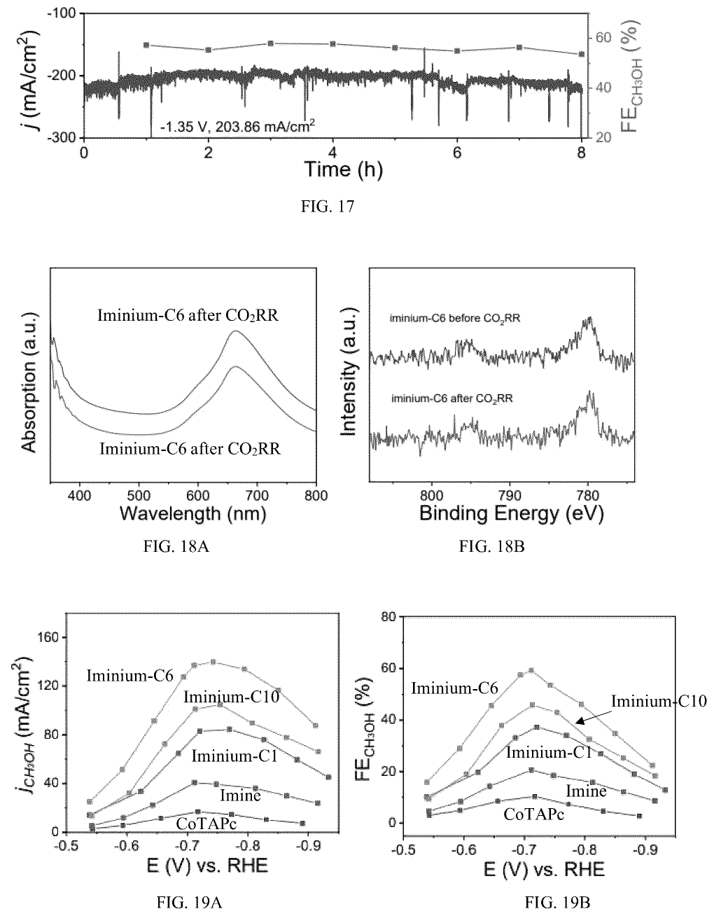

To verify methanol's origin, isotope labeling experiments are conducted. The characteristic doublet of ¹³CH₃OH at 3.54 and 3.06 ppm (FIG. 13G) confirms methanol generation from CO₂ rather than from contaminant sources. Long-term stability testing (FIG. 17) shows that iminium-C6 maintains a stable current density of 203.86 mA·cm⁻² at −1.35 V over 8 hours, with an average FE_{CH3OH} of 57.3%. Post-electrolysis characterizations—including XPS and UV-Vis spectroscopy (FIG. 18)—confirm the chemical stability of the catalyst. The Co 2p XPS peaks show negligible shifts, indicating that the Co(II) center is preserved. Additionally, the UV-Vis spectra before and after electrolysis remain largely unchanged, affirming the structural robustness of iminium-C6 under electrochemical operating conditions.

### Example 3. Methanol Electrosynthesis at Different pHs

The electrocatalytic methanol production from CO₂ reduction is further evaluated under both acidic (pH≈1) and alkaline (pH≈13) conditions through CO₂RR and CORR (CO reduction reaction) processes.

CORR measurements are carried out in a home-made H-cell, with volumes of catholyte and anolyte of 1.75 mL each. 10 mg carbon black together with 50 μL of Nafion solution is dispersed in 10 mL ethanol. Then, 2 mL of this dispersion is mixed with 0.2 mL of dispersion A and sonicated for 15 minutes. Finally, 400 μL of the catalyst ink is drop-cast onto the gas diffusion layer electrode with an area of 2×2 cm².

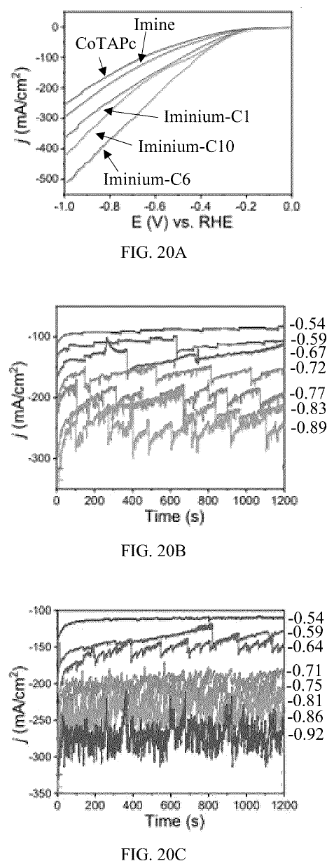

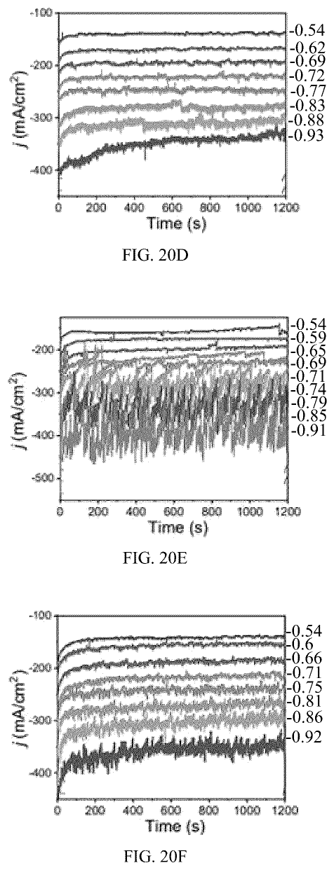

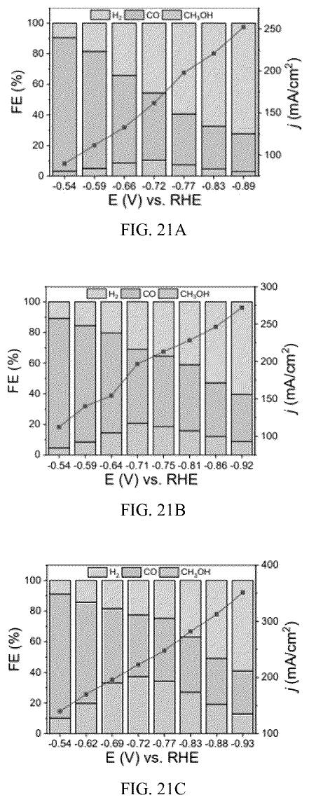

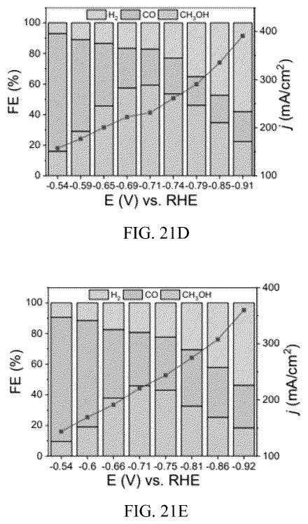

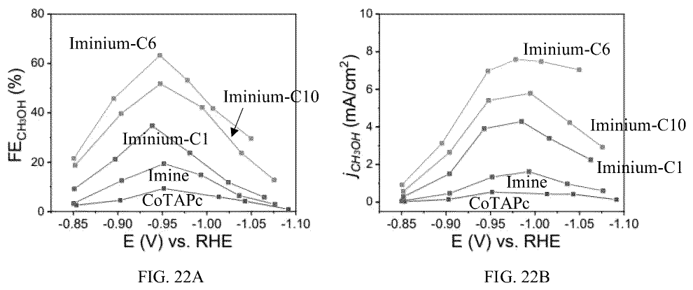

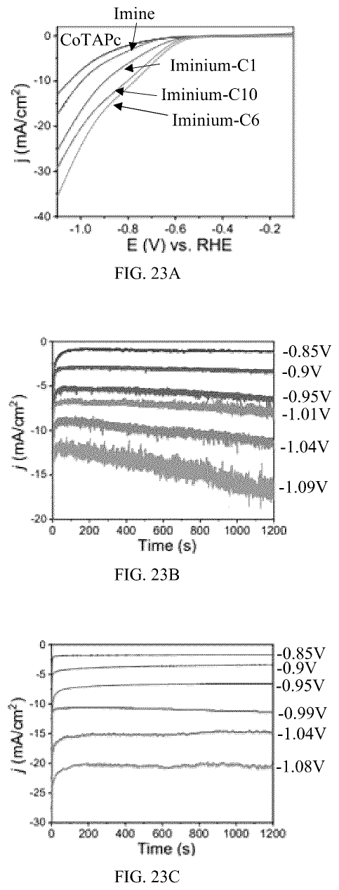

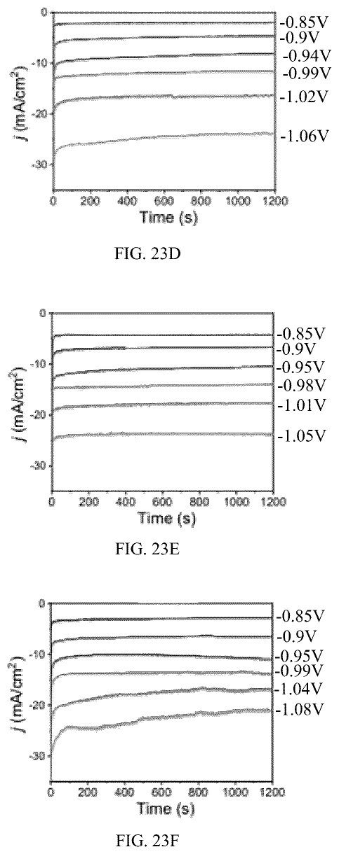

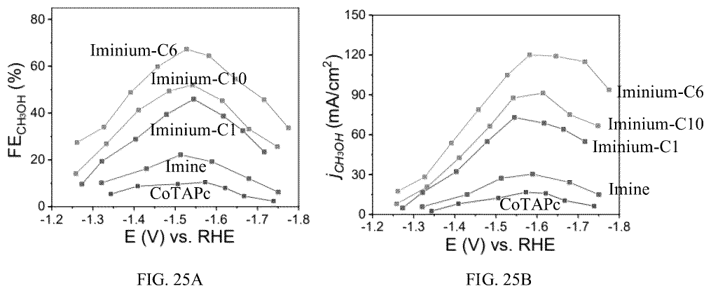

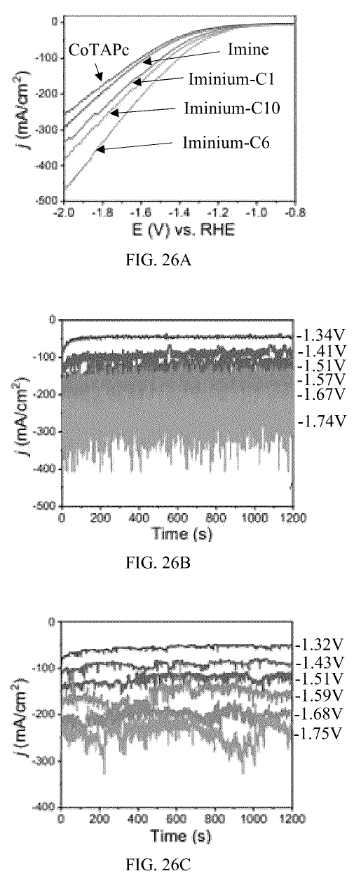

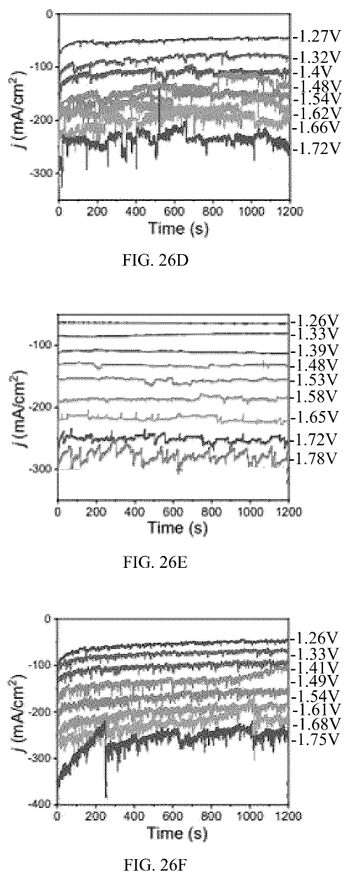

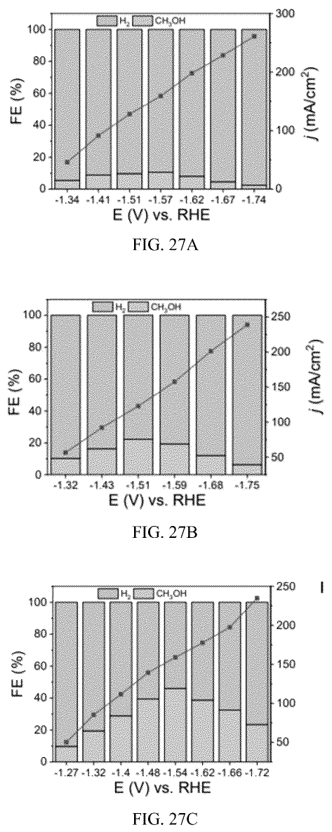

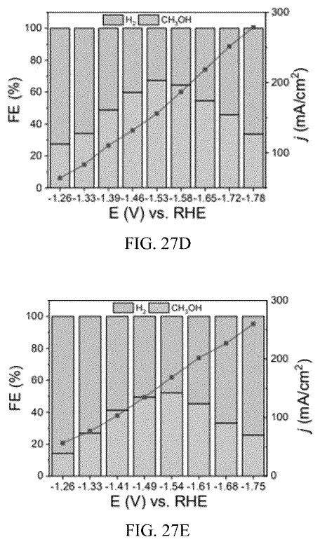

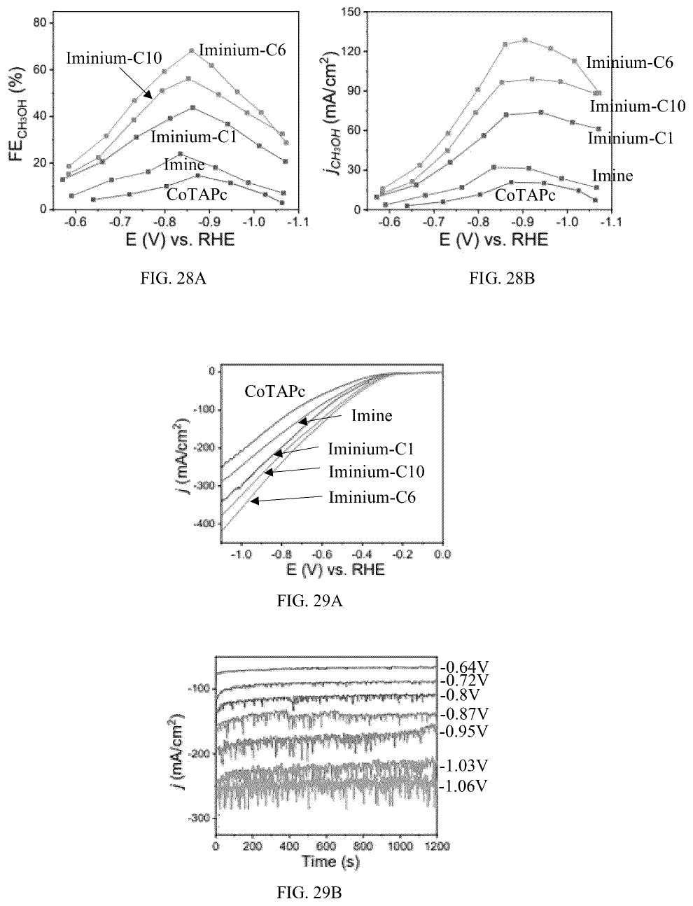

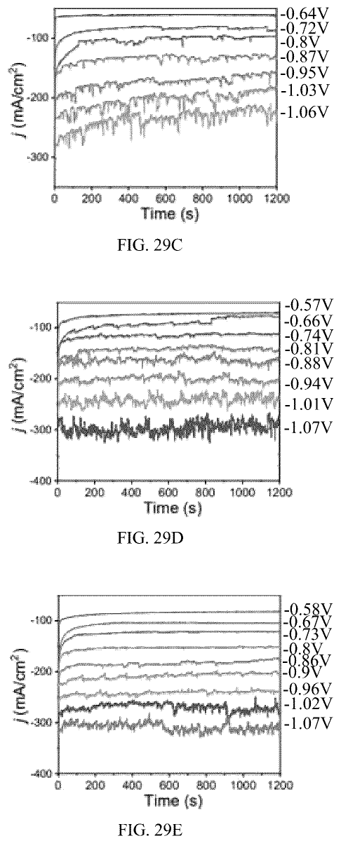

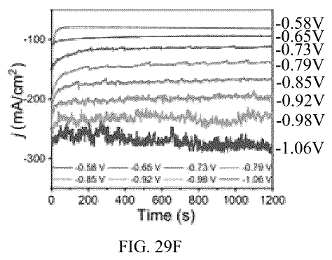

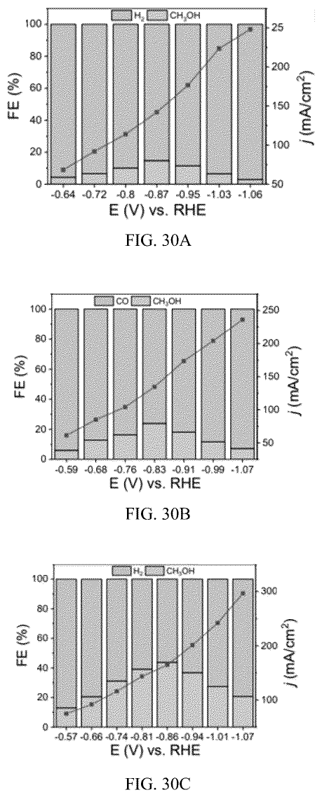

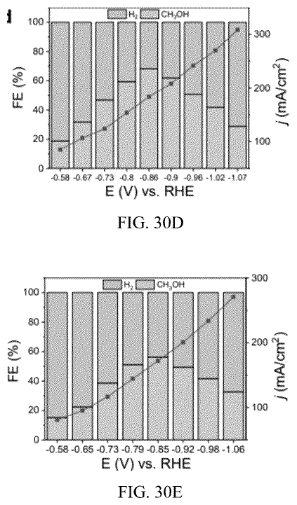

A comparative summary of the maximum FE_{CH3OH} and j_{CH3OH} is presented in FIG. 13H, with full electrochemical characterization provided in FIGS. 19 to 30. Notably, all iminium-functionalized catalysts exhibit higher FE_{CH3OH} under acidic CO₂RR conditions, whereas the unmodified CoTAPc and imine analogs perform better under alkaline conditions. These observations further validate the role of cationic iminium functionality in enhancing CO₂ reduction to methanol in acidic media. Interestingly, the CO₂RR performance of iminium-C6 remains comparable in both acidic and alkaline electrolytes, which is attributed to a similar interfacial environment characterized by high CO surface coverage and suppressed hydronium availability. This finding demonstrates that iminium-C6 is capable of supporting efficient multielectron transfer for methanol production in strong acid, thereby challenging the conventional reliance on alkaline conditions for CO₂-to-methanol conversion.

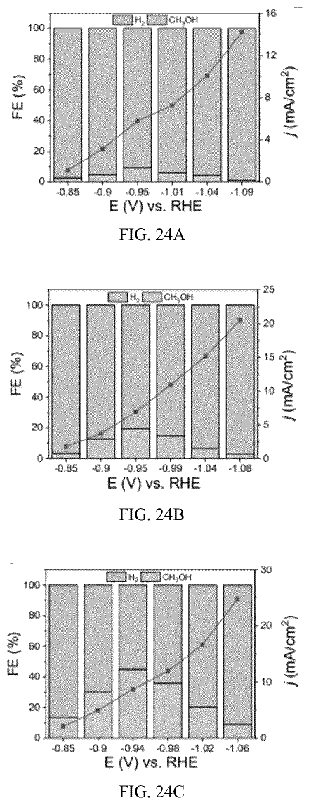

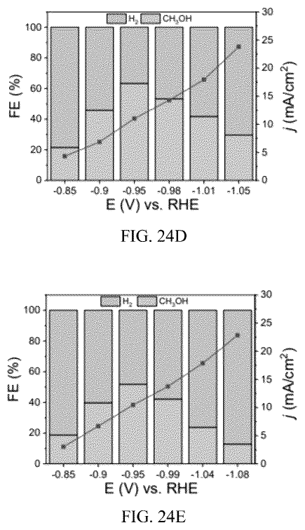

To further elucidate the methanol formation mechanism, CORR are conducted in a CO-fed flow cell. Under these conditions, iminium-C6 achieves the highest FE_{CH3OH} of 67.3%, the lowest competing hydrogen evolution efficiency FE_{H2} of 32.7%, and a methanol partial current density j_{CH3OH} of 104.9 mA cm⁻² at −1.52 V vs. RHE. Consistent with CO₂RR results, iminium-C6 demonstrates the lowest hydrogen Faradaic efficiency and hydrogen current density j_{H2} during CORR (see FIGS. 24, 27, and 30). Although methanol partial current densities during CORR are slightly lower than those observed in CO₂RR, normalization by the number of electron transfer steps reveals minimal variation. This observation suggests that the CO-to-methanol step is likely the rate-limiting step in the overall CO₂-to-methanol pathway. Moreover, it implies that the acrophilic interface introduced by the hydrophobic alkyl chains effectively enhances local CO concentration during CO₂RR, yielding surface CO coverage comparable to direct CO feeding in CORR.

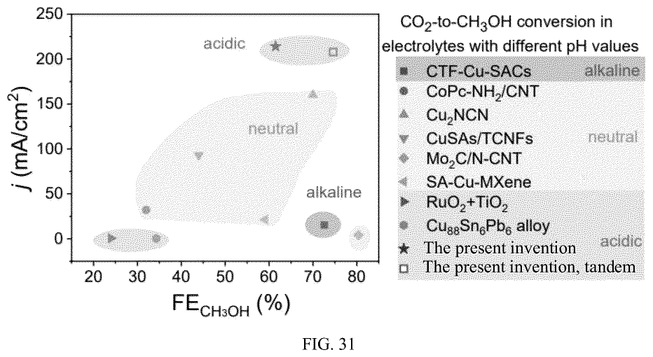

The performance of the present invention is benchmarked against state-of-the-art methanol electrocatalysts, as illustrated in FIG. 31, alongside representative catalysts summarized in FIG. 1C. The iminium-C6 catalyst demonstrates superior CO₂-to-methanol performance under acidic conditions, delivering the highest reported values of FE_{CH3OH} and j_{CH3OH} among known molecular catalysts. Remarkably, the electrocatalytic activity of the present invention in acidic electrolytes is not only comparable to, but in many cases exceeded, the performance of competing systems operating under neutral or alkaline conditions. This highlights the technical advantage of the disclosed strategy for methanol electrosynthesis using molecular catalysts in strongly acidic media.

### Example 4. Mechanistic Investigation

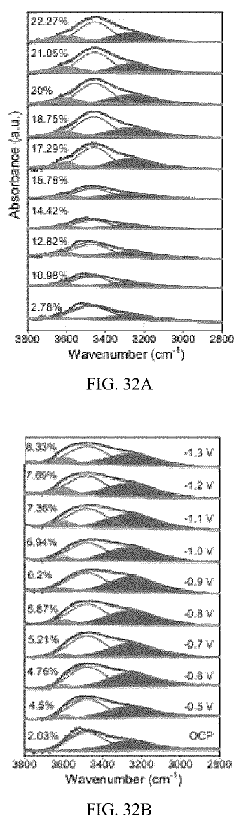

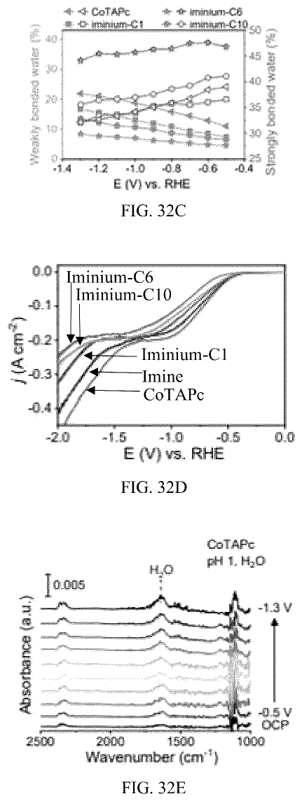

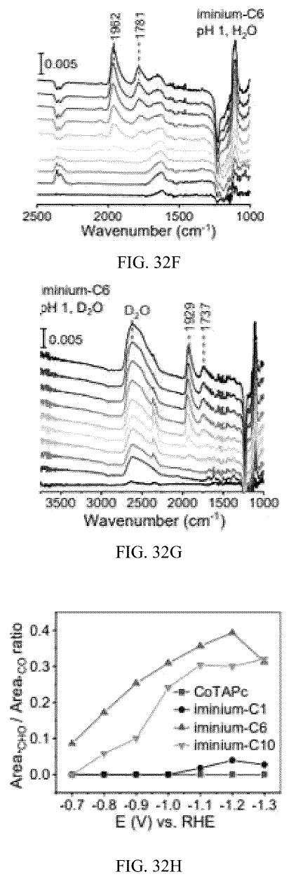

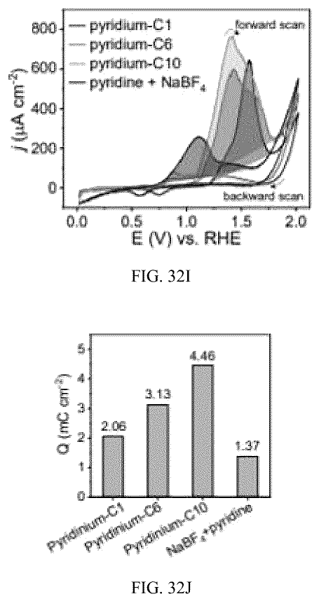

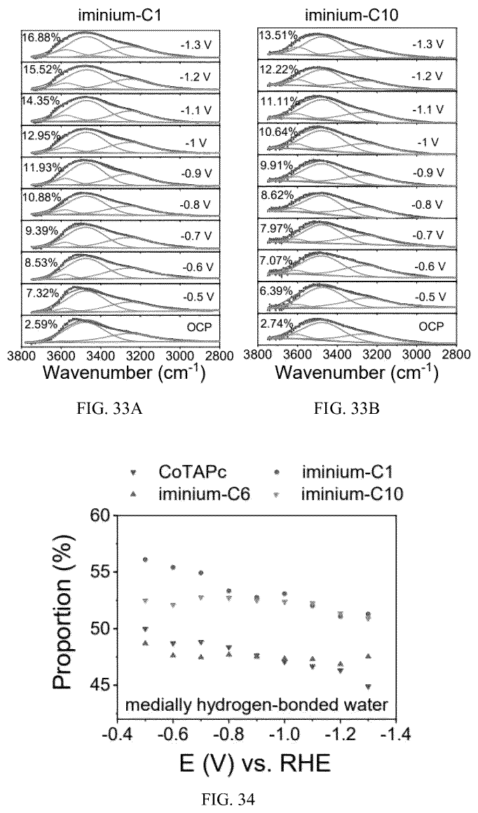

Although the iminium-Cx series catalysts are structurally similar, they exhibit markedly different performances in electrocatalytic CO₂RR. It is hypothesized that these variations in methanol production efficiency originate from extrinsic interfacial factors rather than differences in intrinsic cobalt activity. To explore this, in situ ATR-SEIRAS (attenuated total reflectance surface-enhanced infrared absorption spectroscopy) is conducted in an acidic medium (0.5 M K₂SO₄+0.05 M H₂SO₄) to investigate the structure of interfacial water (FIGS. 32A-32B, 33).

Briefly, in situ ATR-SEIRAS spectroscopy measurements are conducted using a Nicolet™ iS50 FTIR spectrometer, which is equipped with a liquid nitrogen-cooled HgCdTe (MCT) detector. The catalyst inks are prepared by mixing 5 mg electrocatalyst, 5 mg carbon black, 50 μL 5 wt % Nafion solution, and 10 mL ethanol. 1 mL of this ink dispersion is then carefully dropped onto an Au film-coated Si prism (60°, 20×0.95 mm) and dried in air. The ATR-SEIRAS measurements are performed by 32 scans at a spectral resolution of 4 cm⁻¹. The spectrum collected under open circuit voltage (OCP) is used as the background.

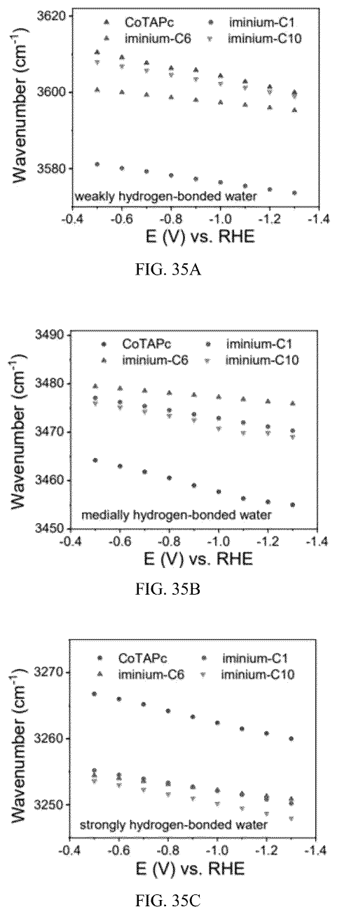

Prior studies have established a strong correlation between water structure at the catalyst interface and hydrogen evolution reaction (HER) activity. The ATR-SEIRAS spectra reveal stretching vibrations of water that can be deconvoluted into three peaks centered near 3600, 3450, and 3250 cm⁻¹, which correspond to weakly, moderately, and strongly hydrogen-bonded water molecules, respectively. The relative proportions of these three states across various catalysts are summarized in FIGS. 32C and 34. In the potential range from −0.5 V to −1.3 V (vs. RHE), iminium-C6 exhibits the highest proportion of strongly hydrogen-bonded water—generally disfavored for HER due to higher water dissociation energy. In contrast, CoTAPc demonstrates a notable increase in weakly hydrogen-bonded water from 10.98% to 22.27%, while iminium-C6 shows only a modest increase from 4.5% to 8.33%. This indicates that the hydrophobic microenvironment provided by the iminium-C6coating effectively suppresses the transition of interfacial water into the ‘two-H-down’ configuration that facilitates HER. Furthermore, iminium-C6 displays a lower Stark tuning rate for water reorientation (FIG. 35), implying weaker interactions between interfacial water and the catalyst surface.

To further understand the correlation between HER activity and interfacial water structure, rotating disk electrode (RDE) measurements are conducted in argon-saturated 0.5 M K₂SO₄+0.05 M H₂SO₄ (FIG. 32D). The RDE electrode is prepared as follows: 2 mg of catalyst and 2 mg of carbon black are combined with 1 mL of ethanol and 20 μL of 5 wt % Nafion solution. This mixture is sonicated for 20 minutes to form a homogeneous ink. Subsequently, 10 μL of the ink is drop-cast onto the RDE (Pine Research) with a diameter of 5 mm and dried at room temperature. The electrolyte is saturated with argon, and LSV curves are recorded at a scan rate of 10 mV/s. The electrolytes used in acidic, neutral, and alkaline environments are 0.5 M K₂SO₄+0.05 M H₂SO₄, 0.5 M K₂SO₄, and 0.1 M KOH+0.45 M K₂SO₄, respectively.

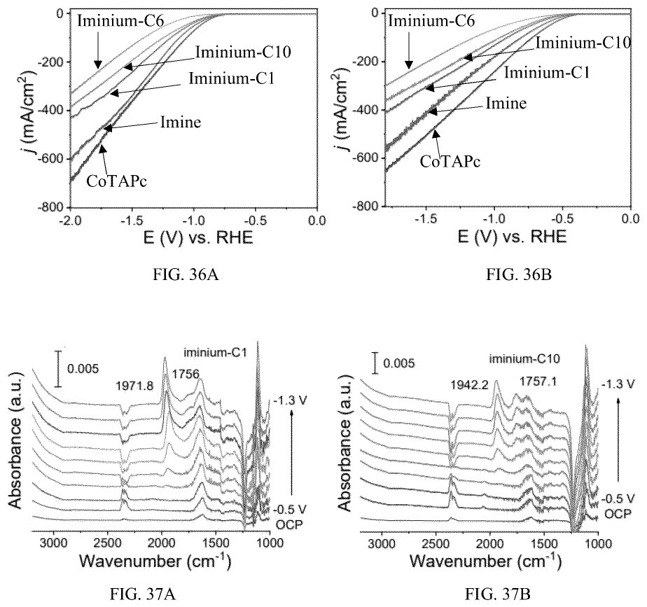

The onset of HER, attributed to hydronium reduction, begins around −0.3 V. Among the samples, iminium-C6 shows the most positive onset potential at −0.38 V and exhibits the lowest current density throughout the range of −0.4 V to −1.35 V, indicating the slowest hydronium reduction kinetics. The inferior HER activity of iminium-C1 compared to both imine and CoTAPc again underscores the effect of electrostatic repulsion from the cationic iminium moieties. At more negative potentials, hydronium becomes depleted, transitioning HER into a diffusion-limited regime with a plateau current near −200 mA cm⁻². At even higher overpotentials, water reduction becomes the dominant pathway. Comparisons of RDE curves under neutral and alkaline conditions (FIG. 36) reveal no plateau, confirming that water reduction alone is operative. Notably, iminium-C6 shows the lowest current densities across all pH conditions, indicating the most effective suppression of water reduction among all catalysts tested. These results collectively demonstrate that the cationic and hydrophobic structure of iminium-C6 effectively suppresses HER via both electrostatic exclusion of hydronium and unfavorable interfacial water configuration.

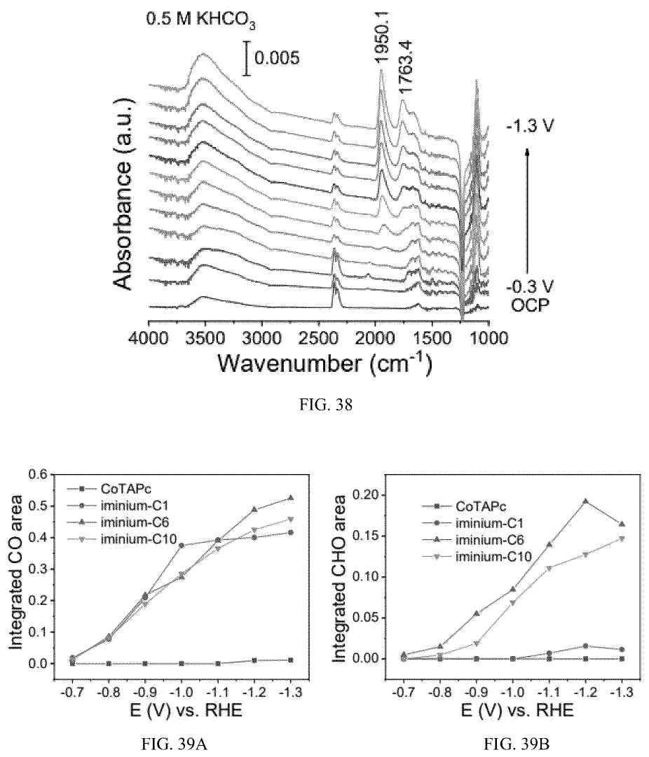

Beyond interfacial water effects, the hydrophobic alkyl chains of the iminium groups enhance local gas solubility and intermediate accumulation. This is supported by intensified spectral signals of reaction intermediates observed in in situ ATR-SEIRAS (FIGS. 32E, 32F, 37). All iminium-modified catalysts exhibit distinct peaks at approximately 1,960 and 1,640 cm−1, corresponding to adsorbed *CO and H₂O, respectively. A notable peak at ˜1,760 cm−1, assigned to the *CHO intermediate, is observed here—unlike prior molecular CO₂RR studies where such signals are undetectable, likely due to low catalyst loading and limited gas solubility. Isotopic substitution with D₂O (FIG. 32G) confirms these assignments, as the O—H stretching signal at ˜3,500 cm⁻¹ shifts to ˜2,600 cm−1 (O-D), and the C═O stretching for *CHO shifts from 1760 cm⁻¹ to 1737 cm⁻¹, consistent with CDO formation. ATR-SEIRAS analysis conducted in neutral media (0.5 M KHCO₃, FIG. 38) on iminium-C6 yields similar peak positions and signal evolution, aligning well with its comparable methanol conversion efficiencies observed in both acidic and neutral electrolytes (FIGS. 13A and 13E).

The surface concentrations of *CO and *CHO intermediates adsorbed on various catalysts are further evaluated by integrating their respective peak areas in the in situ ATR-SEIRAS spectra (FIG. 32H and FIG. 39). Among the tested materials, CoTAPc exhibits only weak *CO adsorption at −1.2 V and −1.3 V, and no detectable *CHO peaks are observed within the tested potential window. For the iminium-C1 catalyst, *CO adsorption reaches a plateau at −1.0 V; however, its *CHO signal remains substantially lower than those of iminium-C6 and iminium-C10. This suggests that the hydrogenation step converting *CO to *CHO is impeded on iminium-C1, likely due to competitive adsorption processes involving *CO₂, desorption of *CO, or *H coverage. In contrast, the iminium-C6 catalyst displays significantly higher *CHO coverage and a greater Area*CHO/Area*CO ratio compared to its counterparts (FIG. 32H). These results imply that the longer alkyl chains on iminium-C6 promote increased local surface concentration of CO, thereby facilitating the multielectron reduction pathway necessary for efficient methanol synthesis.

To further elucidate the role of alkyl chain length in enhancing local CO concentration, CO oxidation experiments are performed on a platinum electrode using a series of pyridinium-based electrolytes (FIG. 321). Briefly, for CO oxidation, 5 mm Pt RDE is used as the working electrode, with 5 mM pyridinium solution as the electrolyte. For the pyridine, 5 mM pyridine+5 mM NaBF₄ are used.

Referring to FIG. 43, upon switching the gas input from argon to carbon monoxide, a CO oxidation peak appears, with integrated charge densities of 1.37, 2.06, 3.13, and 4.46 mC cm⁻² observed in pyridine, pyridinium-C1, pyridinium-C6, and pyridinium-C10, respectively. These values indicate that CO surface coverage increases with the length of the alkyl chain on the pyridinium species. Additionally, cyclic voltammetry (CV) curves for pyridinium-C6 and pyridinium-C10 show pronounced hysteresis between forward and reverse scans, a hallmark of significant surface poisoning caused by high CO accumulation. In contrast, strong cathodic peaks associated with PtOx reduction appear around ˜0.76 V in the pyridinium-C1 and pyridine electrolytes, reflecting lower CO surface coverage and greater water adsorption. Collectively, these results demonstrate that iminium-C6 facilitates enhanced CO solubility and retention at the catalyst interface, attributable to the higher proportion of long-chain alkyl modifications. This conclusion is in general agreement with the in situ ATR-SEIRAS findings and helps explain the superior methanol production performance observed for iminium-C6.

### Example 5. Mechanism Investigations

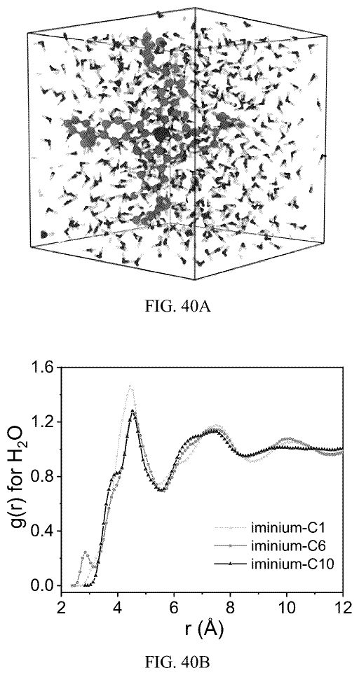

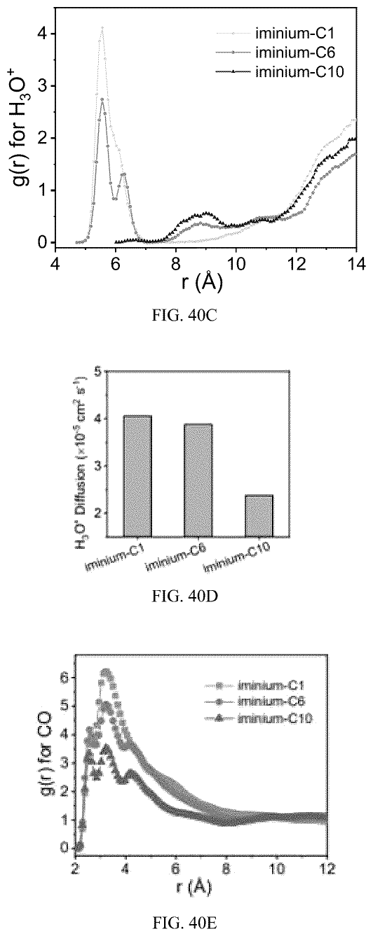

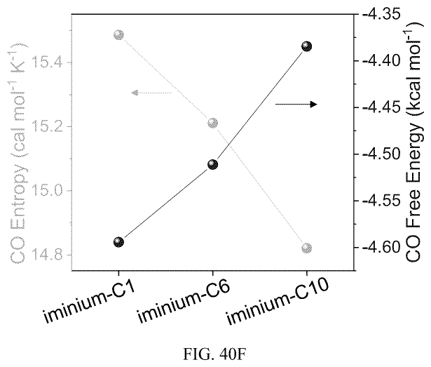

The local microenvironment surrounding the catalytic sites is further evaluated using Molecular Dynamics (MD) simulations. Specifically, the spatial distributions of H₂O and H₃O⁺ around the iminium catalysts with varying alkyl chain lengths are analyzed at 298.15 K and under conditions mimicking the density of liquid water (FIGS. 40A-40C). The radial distribution functions (RDFs, g(r)) for H₂O reveal that iminium-C1 exhibits a primary solvation shell peak at ˜4.5 Å. In contrast, iminium-C6 and iminium-C10 show an additional peak at ˜3.9 Å, indicating a perturbation in H₂O structuring near the surface due to increased hydrophobicity.

RDF analysis of H₃O⁺ distribution near the positively charged quaternary iminium sites shows distinct differences across the three catalysts. For iminium-C1, the first peak at ˜5.6 Å corresponds to H₃O⁺ residing in the second solvation shell around the N⁺ centers (FIG. 40C). Beyond this, the RDF initially drops to zero but gradually increases between ˜9 and 13 Å, suggesting that H₃O⁺ migrates away to minimize electrostatic repulsion with N⁺.

For iminium-C6, a double peak appears at ˜5.6 and 6.2 Å, still indicating second-shell H₃O⁺ localization, but with greater positional fluctuation compared to iminium-C1. The magnitude of the double peak (2.74 and 1.29) is notably lower than the single peak for iminium-C1 (4.12), indicating less frequent H₃O⁺ residence in this region. This aligns with experimental observations showing HER suppression with longer alkyl chains. A secondary compensation peak at ˜8.82 Å is observed, likely due to redistribution of H₃O⁺ further from the N^{′} centers. Beyond this, the RDF again gradually increases to 13 Å.

In the case of iminium-C10, the peak at ˜5.6 Å vanishes, suggesting complete disruption of the N⁺ solvation shell, thus preventing H₃O⁺ from localizing in proximity. Instead, a stronger compensation peak appears at ˜8.8 Å (RDF magnitude=0.53), higher than iminium-C6 (0.37), indicating further displacement of H₃O⁺. The RDF again rises continuously beyond this distance.

These RDF trends are consistent with the observed inhibition of HER as alkyl chain length increases. The MD simulations confirm that as the alkyl chains lengthen, H₃O⁺ is pushed further from the catalyst surface due to disrupted hydrogen bonding and enhanced electrostatic repulsion. The diffusion coefficients of H₃O⁺ were also calculated using the 2-Phase Thermodynamics (2 PT) method (FIG. 40D), revealing reduced H₃O⁺ mobility with longer chains, further impeding hydronium reduction kinetics.

To investigate CO interactions with the catalysts, RDFs of CO molecules around iminium-Cx are also computed (FIG. 40E). For iminium-C1, a peak at ˜3.2 Å reflects CO localization near the molecular plane. For iminium-C6 and iminium-C10, a new peak emerges at ˜2.6 Å, attributed to CO interacting with the hydrophobic alkyl chains. This suggests that the alkyl tails serve as gas reservoirs that improve local CO availability near the active sites, enhancing tandem reduction. Using the 2 PT method, entropy (S) and Helmholtz free energy (A) of CO molecules are computed over 5×20 ps intervals in the last 100 ps (FIG. 40F). As alkyl chain length increases, CO entropy declines—from 15.5 cal mol⁻¹. K⁻¹ (C1) to 15.2 (C6) and 14.8 (C10)—indicating reduced translational freedom due to stronger CO-chain interaction. Consequently, the Helmholtz free energy (A) increases with longer chains, reflecting the lower entropy in accordance with A=U−TS. These findings are consistent with the CO oxidation evaluations (FIG. 32I), which show enhanced CO coverage for iminium-C6 and C10.

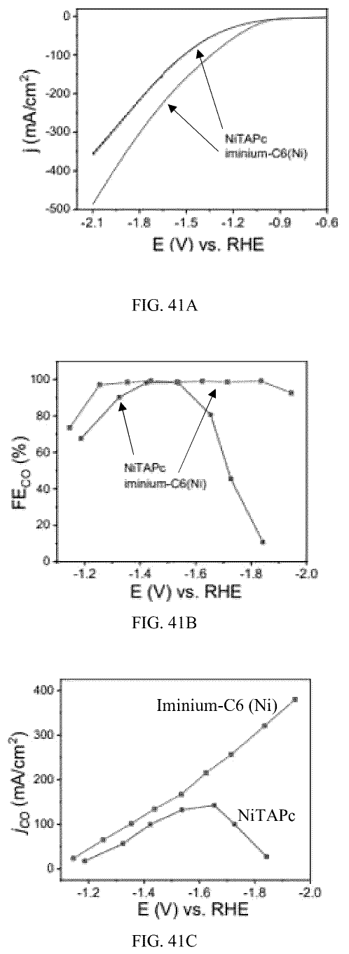

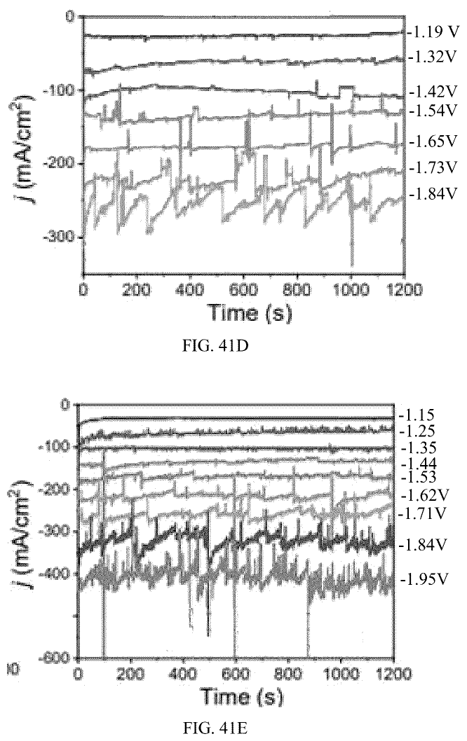

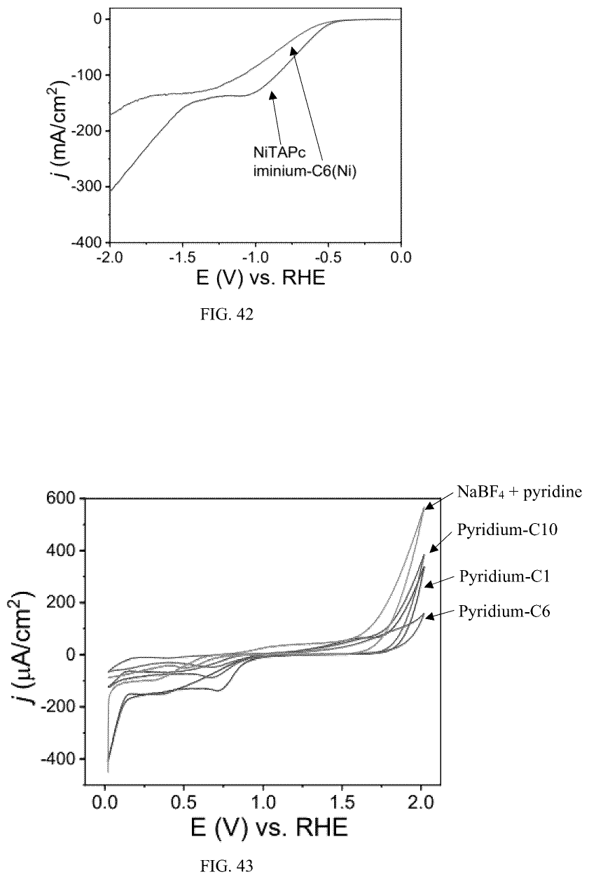

To demonstrate the broader applicability of the method, nickel phthalocyanine (NiPc), a known CO-selective CO₂RR catalyst, is also functionalized with iminium groups. In acidic media, iminium-C6 (Ni) maintains high CO selectivity (>90%) across −1.25 to −1.95 V (FIG. 41), achieving a peak j_{CO} of 380 mA cm⁻² at −1.95 V. In comparison, unmodified NiTAPc exhibits limited acid tolerance, peaking at 142.6 mA cm⁻² and succumbing to HER at higher overpotentials. RDE tests further confirm that iminium-C6 (Ni) displays reduced HER activity compared to NiTAPc (FIG. 42).

In summary, the present invention introduces a novel interface engineering strategy to construct cationic, hydrophobic, and aerophilic catalytic environments for efficient electrochemical CO₂-to-methanol conversion in acidic media. The positively charged iminium sites repel H₃O⁺, thereby suppressing HER, while the hydrophobic alkyl chains create a gas-enriching layer that enhances local CO concentration. These synergistic effects—electrostatic repulsion and van der Waals-driven gas retention—enable superior performance, reaching a FE_{CH3OH} of 61.5% and a j_{CH3OH} of 131.6 mA cm⁻² at −1.37 V in PH≈1 electrolyte. The approach is readily adaptable to other molecular systems, as exemplified by the NiPc catalyst.

This invention demonstrates that precise manipulation of interfacial force fields at the solvent-catalyst boundary can unlock high-performance CO₂ electroreduction in strongly acidic environments.

Compared to the existing technologies, the present invention has several advantages, including:

### Enhanced Efficiency in Strong Acidic Conditions

Conventional CO₂ reduction technologies typically rely on neutral or alkaline electrolytes due to the inherent challenges of operating in strongly acidic environments, such as accelerated hydrogen evolution and catalyst corrosion. The present invention addresses these limitations by enabling efficient electrocatalytic CO₂ reduction in highly acidic conditions (pH≈1). Operating in acid simplifies electrolyte handling and mitigates carbonate formation—a common issue in neutral and alkaline systems that reduces CO₂ utilization efficiency.

### High Methanol Selectivity and Productivity

The disclosed system achieves a methanol partial current density of 132 mA cm−2 with a FE of 62% at −1.37 V_{RHE}. These figures represent a substantial improvement over existing methods, which often struggle to achieve high selectivity and productivity in acidic media. Enhanced selectivity and yield contribute to reduced energy input and improved process economics for methanol synthesis.

### Suppression of the Hydrogen Evolution Reaction (HER)

A key innovation of the invention lies in its ability to suppress the competing hydrogen evolution reaction (HER), which often dominates in acidic environments. This is accomplished through the incorporation of a hydrophobic, aerophilic interfacial layer bearing covalently anchored cationic groups. These structural features repel hydronium ions from the catalyst surface, thereby minimizing undesired H₂ generation and improving the selectivity for CO₂-to-methanol conversion.

### Scalability and Environmental Benefits

The present invention utilizes easily modifiable molecular catalysts, such as cobalt phthalocyanine, functionalized via a scalable post-synthetic strategy. This approach enhances commercial viability by avoiding reliance on complex nanostructures or precious metals. Furthermore, the method promotes carbon capture and conversion, supporting broader efforts to reduce greenhouse gas emissions and environmental impact in industrial applications.

### Cost-Effectiveness and Industrial Relevance

By simultaneously improving selectivity, efficiency, and operational simplicity—especially under acidic conditions that eliminate the need for pH neutralization or specialized electrolyte management—the present invention offers a cost-effective alternative to existing technologies. It is particularly advantageous for industries seeking low-carbon methanol production pathways and reduced dependence on fossil fuel-derived feedstocks.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method for electrochemically reducing carbon dioxide (CO₂) to methanol in an acidic electrolyte in methanol production, comprising:
providing an electrochemical cell comprising a cathode, an anode, and an acidic electrolyte having a pH value below 6;
disposing a modified molecular catalyst on the cathode, wherein the modified molecular catalyst comprises metal phthalocyanine functionalized with covalently attached cationic iminium groups; and
applying an electrical potential to the electrochemical cell to drive a CO₂-to-methanol conversion at the cathode;
wherein the modified molecular catalyst has a hydrophobic and aerophilic interface layer on its surface for promoting local CO availability and suppressing hydrogen evolution reaction (HER).

2. The method of claim 1, wherein the CO₂-to-methanol conversion achieves a methanol Faradaic efficiency (FE) of at least 60% and a methanol partial current density of at least 130 mA cm⁻².

3. The method of claim 1, the metal phthalocyanine comprises one or more of cobalt phthalocyanine (CoPc), nickel phthalocyanine (NiPc), iron phthalocyanine (FePc), and a derivative thereof.

4. The method of claim 1, wherein the cationic iminium groups comprise alkyl chains having at least 6 carbon atoms.

5. The method of claim 4, wherein the alkyl chains comprise 6 or 10 carbon atoms.

6. The method of claim 1, wherein the hydrophobic and aerophilic interface promotes CO surface coverage through van der Waals interactions and inhibits hydronium ion reduction via electrostatic repulsion.

7. The method of claim 1, wherein the applied potential ranges from −1.2 volts to −1.5 volts relative to the potential of a reversible hydrogen electrode (RHE) used as the reference electrode.

8. A catalyst for electrochemical CO₂ reduction, comprising:
a layered nanosheet framework of a metal phthalocyanine comprising one or more of CoPc, NiPc, FePc and a derivative thereof;
wherein the layered nanosheet framework of the metal phthalocyanine is post-synthetically modified with covalently grafted cationic iminium groups having alkyl chains of at least 6 carbon atoms;
wherein the cationic iminium groups introduce a hydrophobic and aerophilic interface to the surface of the catalyst; and
wherein the catalyst exhibits suppressed HER activity and enhanced methanol selectivity in an acidic condition.

9. The catalyst of claim 8, wherein the alkyl chains comprise 6 or 10 carbon atoms.

10. The catalyst of claim 8, wherein the thickness of the layered nanosheet framework of metal phthalocyanine is between 1-2 nm.

11. A system for electrochemical conversion of CO₂ to methanol, comprising:
an electrochemical cell having a cathode, an anode, and a liquid electrolyte with a pH below 6, wherein the cathode is coated with the catalyst of claim 8;
a gas feed configured to supply CO₂ to the cathode compartment; and
a power source configured to apply an electric potential between the cathode and anode;
wherein the system achieves a methanol partial current density of at least 130 mA cm⁻².

12. The system of claim 11, wherein the electrochemical operates continuously with stable FE for methanol exceeding 60%.
